(19) United States
(12) Patent Application Publication
(10) Pub. No.: US 2025/0371501 A1
(43) Pub. Date: Dec. 4, 2025

(54) GENERATING NAVIGABLE OBJECTIVE TIMELINES UTILIZING A LARGE LANGUAGE MODEL

(71) Applicant: Dropbox, Inc., San Francisco, CA (US)

(72) Inventors: Andrew Houston, San Francisco, CA (US); Josh Wilson, San Mateo, CA (US); Ritu Vincent, Alamo, CA (US); Vikrum Nijjar, San Anselmo, CA (US); Rajiv Ayyangar, San Francisco, CA (US)

(21) Appl. No.: 18/675,836

(22) Filed: May 28, 2024

(51) Int. Cl. G06Q 10/1093

(52) U.S. Cl. CPC G06Q 10/1093

(57) ABSTRACT

This disclosure describes embodiments of systems, methods, and non-transitory computer readable storage media that utilize a large language model with user activity data to generate objective timelines for a user account. In particular, the disclosed systems can identify user activity data from a variety of electronic applications utilized by the user account to generate a user account data stream. Furthermore, the disclosed systems can utilize the user account data stream and an identified time objective to generate navigable objective timelines for the user account utilizing a large language model. For instance, the disclosed systems can utilize a large language model with one or more prompts (e.g., time expenditure prompts) generated utilizing the user activity data stream and the time objective. Indeed, the disclosed systems can utilize the large language model with the prompts to generate a navigable objective timeline based on the user activities.

### BACKGROUND

Recent years have seen increasing utilization of digital tools to manage and configure time across user activities and electronic events. For example, some existing time management systems provide tools for users to view, modify, create, or organize user activities or other electronic events via computing devices. In some instances, existing time management systems utilize rule-based automation tools to display, modify, create, or organize user activities or other electronic events between user accounts. Despite such existing time management systems providing tools to view, modify, create, or organize user activities or other electronic events between user accounts, these existing systems face a number of technical shortcomings. Indeed, many existing time management systems often provide inefficient, rigid, and inaccurate tools that require time intensive interactions with inflexible rule-based automation tools to display, modify, create, or organize user activities or other electronic events between user accounts.

For instance, many existing time management systems provide inefficient user interfaces for displaying, modifying, creating, or organizing user activities or other electronic events. In particular, oftentimes, existing time management systems require time intensive user interactions between multiple applications to identify user activities, time schedules or involved user accounts for time management tools. Indeed, in many cases, utilizing existing time management systems can require a significant number of computational resources and screen time (e.g., inefficient battery usage via screen time) to identify or configure data across multiple applications to accomplish the display, modification, creation, or organization of user activities or other electronic events between user accounts.

In response to such inefficiencies, existing time management systems often provide rigid automation tools to assist in managing or organizing user activities or other events. As an example, in some instances, existing time management systems utilize rigid rule-based automation tools that are difficult to utilize and also inflexible. In particular, many existing time management systems enable the configuration of rule-based automation tools that trigger in specific situations. Such rule-based automation tools often do not scale to diverse situations and fail to handle nuances of user activity data across multiple applications and multiple user electronic calendar schedules. In addition, as user activity increases, such existing time management systems require a substantial (and inefficient) number of rule-based triggers to continue functioning for different variations in user activity and electronic calendar schedules.

Moreover, existing time management systems are often inaccurate. For instance, oftentimes, existing time management systems utilize approaches that are unintelligent and unable to react to diverse (and nuanced) situations of user activity data across multiple applications and multiple user electronic calendar schedules. As an example, many existing time management systems that utilize rule-based automation tools often fail to consider the context of user activity data, time objectives, and/or electronic calendar schedules and, as a result, inaccurately display, modify, create, or organize user activities or other electronic events between user accounts using standard or uniform actions regardless of context.

### SUMMARY

This disclosure describes one or more embodiments of systems, methods, and non-transitory computer readable storage media that provide benefits and/or solve one or more of the foregoing and other problems in the art. In particular, the disclosed systems can utilize a large language model with user activity data to generate objective timelines for a user account. In particular, the disclosed systems can identify (or gather) user account activity data from a variety of electronic applications utilized by the user account to generate a user account data stream. Furthermore, the disclosed systems can utilize the user account data stream and an identified time objective corresponding to the user account to intelligently generate navigable objective timelines for the user account utilizing a large language model. For instance, the disclosed systems can utilize a large language model with one or more prompts (e.g., time expenditure prompts) generated utilizing the data stream of user activity data and the time objective. Indeed, the disclosed systems can utilize the large language model with the prompts to generate a navigable objective timeline that indicates a summary of time spent on a particular time objective based on user activities, a suggested time allocation for user activities corresponding to the particular time objective, and/or calendar events for the user activities.

### BRIEF DESCRIPTION OF THE DRAWINGS

The detailed description is described with reference to the accompanying drawings in which:

FIG. 1 illustrates a schematic diagram of an example system in which a digital time objective assistant system operates in accordance with one or more implementations.

FIG. 2 illustrates an overview of a digital time objective assistant system utilizing a large language model to generate time objective timelines in accordance with one or more implementations.

FIG. 3 illustrates an exemplary workflow of a digital time objective assistant system generating a time expenditure prompt and a navigable objective timeline in accordance with one or more implementations.

FIG. 4 illustrates a digital time objective assistant system identifying a data stream of user activities in accordance with one or more implementations.

FIG. 5 illustrates a digital time objective assistant system utilizing a time assistance large language model to tag a user activity utilizing time objective data in accordance with one or more implementations.

FIG. 6 illustrates a digital time objective assistant system utilizing a timeline report assistant large language model to generate a navigable objective timeline report in accordance with one or more implementations.

FIG. 7 illustrates a digital time objective assistant system utilizing a prioritization assistant large language model to generate a time allocation suggestion in accordance with one or more implementations.

FIG. 8 illustrates a digital time objective assistant system utilizing a scheduling assistant large language model to generate electronic calendar events in accordance with one or more implementations.

FIGS. 9-15 illustrate a digital time objective assistant system displaying graphical user interfaces with various navigable objective timelines generated utilizing a large language model in accordance with one or more implementations.

FIGS. 16A-16D illustrate a digital time objective assistance system receiving and utilizing a user prompt to generate an electronic calendar event utilizing a large language model in accordance with one or more implementations.

FIG. 17 illustrates a digital time objective assistant system utilizing a scheduling assistant large language model to generate fluid user activity events in accordance with one or more implementations.

FIG. 18 illustrates a flowchart of a series of acts for utilizing a large language model with user activity data to generate time objective timelines for user accounts in accordance with one or more implementations.

FIG. 19 illustrates a block diagram of an exemplary computing device in accordance with one or more implementations.

FIG. 20 illustrates an example environment of a networking system in accordance with one or more implementations.

### DETAILED DESCRIPTION

This disclosure describes one or more embodiments of a digital time objective assistant system that utilizes a large language model with user activity data to intelligently and automatically generate time objective timelines for user accounts. In particular, in one or more implementations, the digital time objective assistant system can identify (or collect) data from one or more applications corresponding to a user account to generate a data stream representing a set of user account activities for the user account (across the one or more applications). In addition, the digital time objective assistant system can determine a time objective for the user account. Moreover, the digital time objective assistant system can utilize the data stream of user account activities and the time objective to generate a time expenditure prompt having parameters to convert the data stream into a displayable format for an objective timeline. Indeed, the digital time objective assistant system can provide the time expenditure prompt to a large language model to generate a navigable objective timeline. In one or more implementations, the navigable objective timeline includes a summary of time spent on a particular time objective based on user activities, a suggested time allocation for user activities corresponding to the particular time objective, and/or calendar events for the user activities.

In some instances, the digital time objective assistant system can utilize one or more large language models as timeline objective assistant models for the user account. For instance, the digital time objective assistant system can utilize a timeline report assistant large language model, a prioritization assistant large language model, and/or a scheduling assistant language model that communicate (or utilize) one or more time expenditure prompts from user account activity data to generate navigable objective timelines for the user account. In some cases, the timeline report assistant large language model, a prioritization assistant large language model, and/or a scheduling assistant language model can utilize outputs of each model as input prompts to generate navigable objective timelines (e.g., a summary of time spent on a particular time objective based on user activities, a suggested time allocation for user activities corresponding to the particular time objective, and/or calendar events for the user activities).

Additionally, the digital time objective assistant system can identify time objectives corresponding to a user account (e.g., projects with project descriptors for a user account, goals or tasks defined by a user account). In addition, the digital time objective assistant system can generate a data stream of user activities (e.g., electronic communications, content items, electronic calendar events, notetaking application entries, video call application interactions) from one or more applications utilized by the user account. Indeed, the digital time objective assistant system can utilize a large language model to identify user activities from the data stream that correspond with (or are relevant to) the one or more time objectives and label the user activities with the relevant one or more time objectives.

As an example, the digital time objective assistant system can identify one or more user activities tagged with particular time objectives (e.g., tagging a particular electronic calendar event with a particular time objective). Furthermore, the digital time objective assistant system can utilize a large language model that learns to tag additional user activities corresponding to the user account (across one or more applications) with particular time objective tags. Indeed, the digital time objective assistant system can utilize the tagged user activities with a large language model (e.g., the timeline report assistant large language model, a prioritization assistant large language model, and/or a scheduling assistant language model) to generate navigable objective timelines.

For instance, the digital time objective assistant system can utilize the tagged user activities (with time objective data) to generate time expenditure prompts for a timeline report assistant large language model. Indeed, the digital time objective assistant system can utilize the timeline report assistant large language model with a time expenditure prompt to generate a navigable objective timeline that indicates time objective and user activity summaries. For instance, the time objective and user activity summaries can represent an amount of time spent on particular user activities related to time objective or unrelated to a time objective and/or user activities determined to relate to a time objective.

Furthermore, the digital time objective assistant system can identify user account priorities for time objectives. For instance, the digital time objective assistant system can utilize a large language model (e.g., the timeline report assistant large language model) to analyze user activity data to determine one or more user account priorities for particular time objectives. In some cases, the digital time objective assistant system can determine, from relevancies between user account activity data and time objectives, one or more time objectives predicted to be prioritized by the user account. For example, the digital time objective assistant system can determine a time objective to prioritize for a user account based on user activity data related to the time objective in comparison to user activity data related to other time objectives.

In addition, upon determining (or receiving) an indication of user account priorities of time objectives for a user account, the digital time objective assistant system can generate or store text descriptors for time objective priorities (e.g., as part of a time expenditure prompt). Indeed, the digital time objective assistant system can define and store time objective priorities at different levels of granularity, from macro priorities that describe or represent (e.g., as text prompts) an open-ended time objective (with open-ended timeframes) to micro priorities that describe or represent a specific time objective (for a specific timeframe).

Furthermore, the digital time objective assistant system can utilize the tagged user activities (with time objective data) to generate time expenditure prompts for a prioritization assistant large language model. In particular, the digital time objective assistant system can utilize the prioritization assistant large language model with a time expenditure prompt to generate a navigable objective timeline that indicates or determines time priorities and/or time priority allocations for user activities of a user account based on time objectives. For example, the digital time objective assistant system can provide a user activity data stream and a time objective descriptor (with determined priority information), as a time expenditure prompt, to the prioritization assistant large language model to generate a time allocation suggestion for one or more user activities relevant to the time objective. As an example, the digital time objective assistant system can utilize a time expenditure prompt representing the user activity data corresponding to a time objective and a descriptor for a priority of the time objective to generate a time allocation suggestion that indicates suggested times for the one or more user activities (e.g., to finish or accomplish the time objective within a time constraint). In some cases, the digital time objective assistant system utilizes one or more user account priorities for particular time objectives (generated by the timeline report assistant large language model) as part of an input time expenditure prompt to the prioritization assistant large language model to generate a time allocation suggestion.

In addition, the digital time objective assistant system can generate time expenditure prompts utilizing user activity data streams (and/or time objective data) to generate electronic calendar events. In particular, the digital time objective assistant system can utilize a scheduling assistant large language model, with input time expenditure prompts, to generate calendar events for one or more user activities (as navigable objective timelines). For instance, the digital time objective assistant system can utilize identified user activities in a user account data stream, with time objective tags, to generate particular electronic calendar events for the tagged user activities. Additionally, in some cases, the digital time objective assistant system can also utilize time allocation suggestions, generated as described above, as part of a time expenditure prompt in the scheduling assistant language model. Indeed, the digital time objective assistant system can utilize a time allocation suggestion as an input prompt to generate electronic calendar events to match the time allocation suggestion for the user activities. Furthermore, the digital time objective assistant system can also tag a generated electronic calendar event with a relevant time objective. In addition, the digital time objective assistant system can also generate a fluid electronic calendar event that is modifiable (e.g., by the large language model) based on updates to one or more user account electronic calendar events, updates to time objective priorities, and/or one or more predicted time allocation suggestions for one or more user accounts.

The digital time objective assistant system provides several technical advantages over existing time management tool systems. For instance, the digital time objective assistant system 106 provides efficient, flexible, and accurate tools to intelligently and automatically generate navigable objective timelines from user activity data of multiple applications for a user account. In particular, the digital time objective assistant system 106 provides a practical application that can generate intelligent and dynamic time expenditure prompts from user activity data streams to feed into one or more large language models to generate a navigable objective timeline that indicates a summary of time spent on a particular time objective based on user activities, a suggested time allocation for user activities corresponding to the particular time objective, and/or electronic calendar events for the user activities.

For example, in contrast to existing systems that often require time intensive user interactions between multiple applications to utilize time management tools, the digital time objective assistant system 106 can automatically and intelligently determine user activity summaries and reports, time allocation suggestions, and generate electronic calendar events based on user activity across multiple applications with less time intensive user navigation. Indeed, the digital time objective assistant system 106 can enable users to view insightful summaries of user activities for time objectives corresponding to the user account, generate time allocation suggestions, and electronic calendar events utilizing simple request commands (e.g., simple text and/or voice prompts). In response to the simple request commands, the digital time objective assistant system 106 can generate dynamic and nuanced time expenditure prompts that account for user activity data streams and time objectives corresponding to the user account for a large language model to generate the navigable objective timelines. Indeed, the digital time objective assistant system 106 can enable automatic and intelligent determinations of user activity summaries and reports, time allocation suggestions, and electronic calendar events with reduced computation resources and reduced battery consumption (for screen time) due to a reduction in user interaction and navigation between multiple applications to utilize such digital time management tools.

The digital time objective assistant system 106 also improves the flexibility of digital time management tools. For instance, in contrast to rigid rule-based tools of many existing systems, the digital time objective assistant system 106 facilitates adaptive and intelligent digital time management tools. To illustrate, the digital time objective assistant system 106 can determine user activity summaries and reports, time allocation suggestions, and generate electronic calendar events based on user activity across multiple applications using nuanced and customized time expenditure prompts generated by the digital time objective assistant system 106. Indeed, by generating the time expenditure prompts, the digital time objective assistant system 106 can scale to cover a variety of user activity from various applications within the time expenditure prompt provided to a large language model without user configuration of individual rule-based triggers.

Furthermore, in contrast to many existing rule-based automation tools from existing systems, the digital time objective assistant system 106 accurately generates user activity summaries and reports, time allocation suggestions, and electronic calendar events by leveraging a time expenditure prompt that accounts for user activity data across multiple applications and time objective data for a user account (with a large language model). Indeed, unlike many existing systems, the digital time objective assistant system 106 can account for a substantial number of user activities that correspond to the user account. In addition, unlike trigger-based or rule-based tools that do not consider context of user activities, the digital time objective assistant system 106 utilizes a large language model with a time expenditure prompt created from user activity data streams of a user account and time objectives for the user account to generate user activity summaries and reports, time allocation suggestions, and electronic calendar events that accurately consider context of the user activities.

As illustrated by the foregoing discussion, the present disclosure utilizes a variety of terms to describe features and benefits of the digital time objective assistant system 106. Additional detail is now provided regarding the meaning of these terms. As used herein, the term “content” (or sometimes referred to as “content item,” “content,” “media content file,” “digital content,” or “media content”) refers to discrete data representation of a document, file, image, or video. In particular, a digital content item can include, but is not limited to, a digital image (file), a digital video (file), an electronic document (e.g., text file, spreadsheet, PDF, forms), and/or electronic communication (e.g., one or more instant messages, e-mails).

As also used herein, the term “user account activity” refers to a user interaction with one or more applications. For instance, the term user account activity can refer to user interactions with, but not limited to, one or more digital content items, one or more electronic calendar events, one or more electronic communication threads. As an example, a user account activity can include, but is not limited to, a user interaction with an electronic communication (e.g., an instant message, an email), a user interaction to generate a prompt (e.g., a search prompt, a prompt for a large language model), a user interaction with an electronic calendar (e.g., the creation of an electronic calendar event, status changes on the electronic calendar events, RSVPs (e.g., acceptance, rejection) to electronic calendar events, and/or interactions within an electronic communication (e.g., generating user electronic communications, viewing user electronic communications, and/or deleting electronic communications).

As used herein, the term “application” (sometimes referred to as “electronic application”) refers to an executable program or software to enable user interactions for (or with), but not limited to, electronic communications, electronic calendars, and/or digital content. For example, an application can include an electronic document editor application and/or a digital content editor (e.g., an image editing application) that enables user interactions to create, modify, view, and/or share digital content items (e.g., electronic documents, digital images, digital videos). In addition, an application can also include, but is not limited to, messaging applications, calendaring applications, video call applications, and/or notetaking applications.

As used herein, the term “time objective” refers to a user event (or task). In particular, a time objective can include a user event or task having a particular goal as the user event or task and/or a time constraint for the particular goal. In some instances, a time objective can include a project name indicating a set of tasks, events, or goals and/or a sub-task for a project. As an example, a time objective can include tasks, events, or goals, such as, but not limited to, a project name (e.g., “Project Game 1,” “Project Video 1”), a task (e.g., “finish outline for project game 1,” “finish color editing for video 1”), and/or an event (e.g., “attend video 1 editing meeting,” “attend project stand up meeting”). In some instances, a time objective includes a time constraint to indicate a time of completion for the time objective (e.g., a deadline or due date). As an example, a time objective can include a time constraint such as, but not limited to “finish in 10 days” or “due in 2 months”).

As used herein, the term “data stream” refers to a collection of user activity data across one or more electronic applications. In particular, a data stream can include a plurality of user activity data of a user account from various applications. In addition, a data stream can include user activity data for user activity history for a collaborative content item (or set of content items) (e.g., a project or collaboration). In some cases, the data stream can also include user activity data involving multiple user accounts (e.g., user accounts that interact with a particular user account) across one or more applications. Moreover, the data stream can also include user activity data of one or more user accounts for one or more applications corresponding to a particular content item and/or collection of content items (e.g., a project or collaboration to create a project-specific data stream).

As used herein, the term “time expenditure prompt” (or sometimes referred to as “prompt”) refers to a set of input parameters for a machine learning model to cause the machine learning model to generate a navigable (or displayable) objective timeline (or other output). In particular, a time expenditure prompt can include a set of input parameters represented as an input string of text that includes one or more parameters (or variables) and/or requests for a machine learning model (e.g., a large language model). For example, the time expenditure prompt can include one or more requests or commands (as text) to a large language model. In addition, the time expenditure prompt can include (as text) one or more parameters (or variables), such as, but not limited to, user activity data via a data stream, time objective data corresponding to one or more user accounts, and/or one or more outputs from one or more large language models (e.g., a timeline report assistant model, a prioritization assistant model, a scheduling assistant model).

As an example, the digital time objective assistant system can generate a time expenditure prompt that includes (in text format) user activity data for a user across multiple applications, time objective data, and a request to generate a particular output (e.g., generate a timeline report, generate a suggested time allocation, schedule user activities or events for a time objective).

Furthermore, as used herein, the term “machine learning model” refers to a computer representation that can be tuned (e.g., trained) based on inputs to approximate unknown functions. Indeed, a machine learning model can refer to a computer representation that can be tuned (e.g., trained) based on inputs to generate navigable objective timeline data (e.g., time objective reports, time objective priorities, suggested time allocations for user activities, electronic calendar events). Additionally, a machine learning model can refer to a computer representation that can be tuned (e.g., trained) based on inputs to analyze prompts (e.g., time expenditure prompts having user activity data, time objective data, and/or objective timeline generation requests). In one or more implementations, parameters of a machine learning model can be adjusted or trained to create a generative neural network that intelligently generates navigable objective timeline data from time expenditure prompts (e.g., text including user activity data, time objective data, and/or other machine learning outputs) to represent actionable content (e.g., time reports, time allocations, electronic calendar events) for a user account based on dynamic data corresponding to the user account (e.g., user activities across one or more applications, time objective data, user account data of one or more user accounts).

For instance, a machine learning model can include, but is not limited to, one or more convolutional neural networks, recurrent neural networks, generative adversarial neural networks), residual neural networks, diffusion models, or a combination thereof. Additionally, a machine learning model can also include, but is not limited to one or more large language models, differentiable function approximators, contrastive language-image pre-training models, clustering models, convolution neural network-based image classifiers, recurrent neural network-based image classifiers, Term Frequency Inverse Document Frequency (TF-IDF) encoders, Word2Vecs, matrix factorization vector learning approaches, local context window vector learning approaches, Global Vectors for Word Representation (GloVe), Bidirectional Encoder Representations from Transformers, natural language processing approaches (e.g., spaCy), and/or generative pre-trained transformer models.

In addition, as used herein, the term “large language model” refers to one or more neural networks (machine learning models) that can process natural language text to generate outputs that range from predictive outputs, analyses, generated tasks, and/or executions for user activities (or time objectives) (or combination thereof). For instance, the digital time objective assistant system can utilize a large language model with a time expenditure prompt (e.g., as a natural language text prompt) to generate one or more navigable objective timeline outputs (as described herein). In particular, a large language model can include parameters trained (e.g., via deep learning) on large data volumes to learn patterns and rules of language for summarizing, analyzing, and/or generating outputs (e.g., navigable timeline objectives). For example, a large language model can include a BLOOM model, a Bard AI model, and/or a ChatGPT model (e.g., GPT-3, GPT-4, etc.).

Furthermore, a machine learning model can include an artificial intelligence context engine model that utilizes machine learning (e.g., one or more LLMs) with context from data or descriptions corresponding to a user account (and/or multiple user accounts on a content management system) to generate outputs that range from predictive outputs, analyses, generated tasks, and/or executions for user activities (or time objectives) (or combination thereof). Although one or more embodiments illustrate the digital time objective assistant system utilizing an LLM, the digital time objective assistant system can utilize a variety of machine learning models in accordance with one or more implementations herein.

As used herein, the term “navigable objective timeline” refers to an output of a machine learning model in response to a time expenditure prompt. In particular, a navigable objective timeline can include an organized, transformed, and/or generated displayable data format (by a machine learning model) that represents a summarization, recommendation, or action in response to a time expenditure prompt (e.g., a prompt having user activity data and/or time objective data for a user account). For instance, a navigable objective timeline can include a user timeline report based on one or more user activities corresponding to the user account and/or one or more time objects corresponding to the user account (e.g., a summary of time spent on a time objective, a comparison of time spent between time objectives). Additionally, a navigable objective timeline can include prioritization features for a user account (e.g., a suggested time allocation of user activities for one or more time objectives, estimated times for completion of user activities, user activity priorities). Moreover, a navigable objective timeline can include one or more generated electronic calendar events based on one or more user activities, one or more time objectives, and/or one or more prioritization features corresponding to a user account.

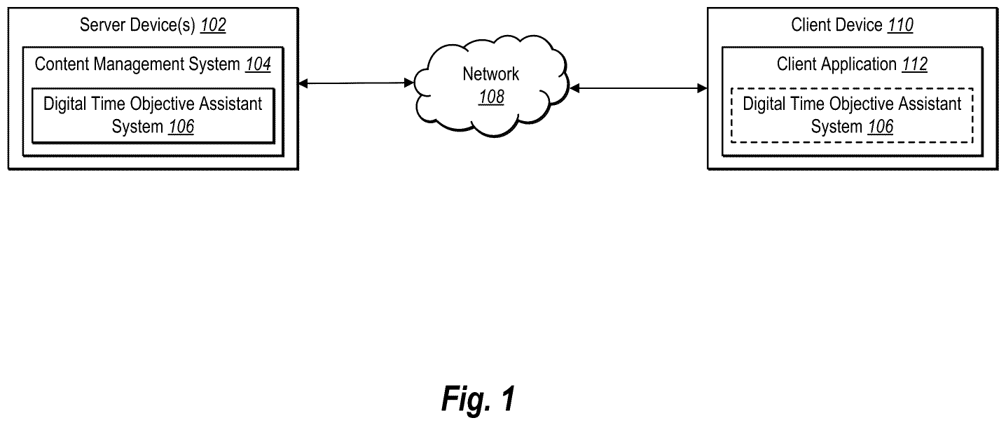

Turning now to the figures, FIG. 1 illustrates a schematic diagram of one implementation of a system 100 (or environment) in which a digital time objective assistant system 106 operates in accordance with one or more implementations. As illustrated in FIG. 1, the system 100 includes server device(s) 102, a network 108, and a client device 110. As further illustrated in FIG. 1, the server device(s) 102 and the client device 110 communicate via the network 108.

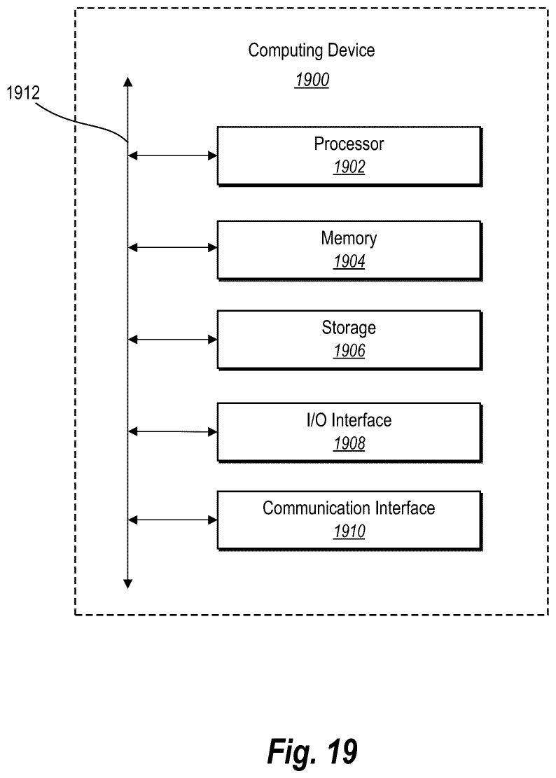

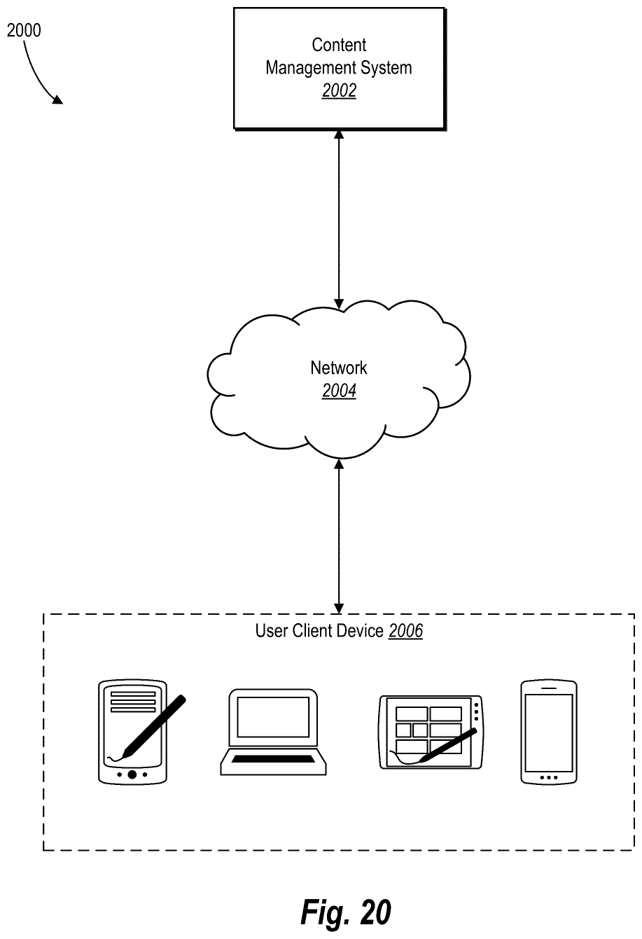

As shown in FIG. 1, the server device(s) 102 include a content management system 104, which further includes the digital time objective assistant system 106. In particular, the content management system 104 provides functionality by which a user (not shown in FIG. 1) can use the client device 110 to generate, manage, and/or store digital content. For example, a user can generate digital content using the client device 110. Subsequently, a user utilizes the client device 110 to send the digital content to the content management system 104 hosted on the server device(s) 102 via the network 108. The content management system 104 can then provide many options that the client device 110 may utilize (and a user selects or otherwise interacts with) to store the digital content, organize the digital content, share the digital content, and subsequently search for, access, view, and/or modify the digital content. Additional detail regarding the content management system 104 is provided below (e.g., in relation to FIG. 20 and the content management system 2002). Furthermore, the server device(s) 102 can include, but are not limited to, a computing (or computer) device (as explained below with reference to FIG. 19).

As further shown in FIG. 1, the system 100 includes the client device 110. In one or more implementations, the client device 110 include, but are not limited to, mobile devices (e.g., smartphones, tablets), laptops, desktops, or other types of computing devices, as explained below with reference to FIG. 19. For example, the client device 110 can be operated by users to perform various functions (e.g., via the client application 112) such as, but not limited to, creating, receiving, viewing, modifying, and/or transmitting digital content and/or electronic communications, receiving and/or facilitating user activities with one or more applications, configuring user account or application settings of the content management system 104, and/or utilizing or interacting with one or more time assistance large language models of the digital time objective assistant system 106. Although FIG. 1 illustrates a single client device 110, in one or more embodiments, the system 100 can include various numbers and types of client devices.

To access the functionalities of the content management system 104 (and the digital time objective assistant system 106), a user can interact with the client application 112 via the client device 110. The client application 112 can include one or more software applications installed on the client device 110. In some implementations, the client application 112 can include one or more software applications that are downloaded and installed on the client device 110 to include an implementation of the digital time objective assistant system 106 and/or to facilitate one or more user activities on one or more applications. In some embodiments, the client application 112 is hosted on the server device(s) 102 and is accessed by the client device 110 through a web browser and/or another online platform. Moreover, the client application 112 can include functionalities to access or modify a file storage structure stored locally on the client device 110 and/or hosted on the server device(s) 102.

As just mentioned and as shown in FIG. 1, the server device(s) 102 include the digital time objective assistant system 106 (through the content management system 104). In one or more instances, the digital time objective assistant system 106 utilizes a large language model with user activity data to generate objective timelines for a user account. For instance, the digital time objective assistant system 106 can utilize the user account data stream and an identified time objective (as converted time expenditure prompts) corresponding to the user account to intelligently generate navigable objective timelines for the user account utilizing a large language model. Indeed, the digital time objective assistant system 106 can utilize the large language model with the prompts to generate a navigable objective timeline that indicates a summary of time spent on a particular time objective based on user activities, a suggested time allocation for user activities corresponding to the particular time objective, and/or calendar events for the user activities.

Although FIG. 1 illustrates the digital time objective assistant system 106 being implemented by a particular component and/or device within the system 100 (e.g., the server device(s) 102), in some embodiments, the digital time objective assistant system 106 is implemented, in whole or part, by other computing devices and/or components in the system 100. For example, in some implementations, the digital time objective assistant system 106 is implemented on the client device 110 within the client application 112. More specifically, in some embodiments, some or all of the digital time objective assistant system 106 is implemented by the server device(s) 102 and accessed by the client device 110 through the client application 112, web browsers, and/or other online platforms (as described above). In some instances, some or all of the digital time objective assistant system 106 is implemented by the client device 110 on the client application 112 and communicates data (or changes to data) to the content management system 104 on the server device(s) 102.

Additionally, as illustrated in FIG. 1, the system 100 includes the network 108 that enables communication between components of the system 100. In certain implementations, the network 108 includes a suitable network and may communicate using any communication platforms and technologies suitable for transporting data and/or communication signals between the server device(s) 102 and the client device 110. An example of the network 108 is described with reference to FIG. 19 and/or FIG. 20. Furthermore, although FIG. 1 illustrates the server device(s) 102 and the client device 110 communicating via the network 108, in certain implementations, the various components of the system 100 communicate and/or interact via other methods (e.g., the server device(s) 102 and the client device 110 communicating directly).

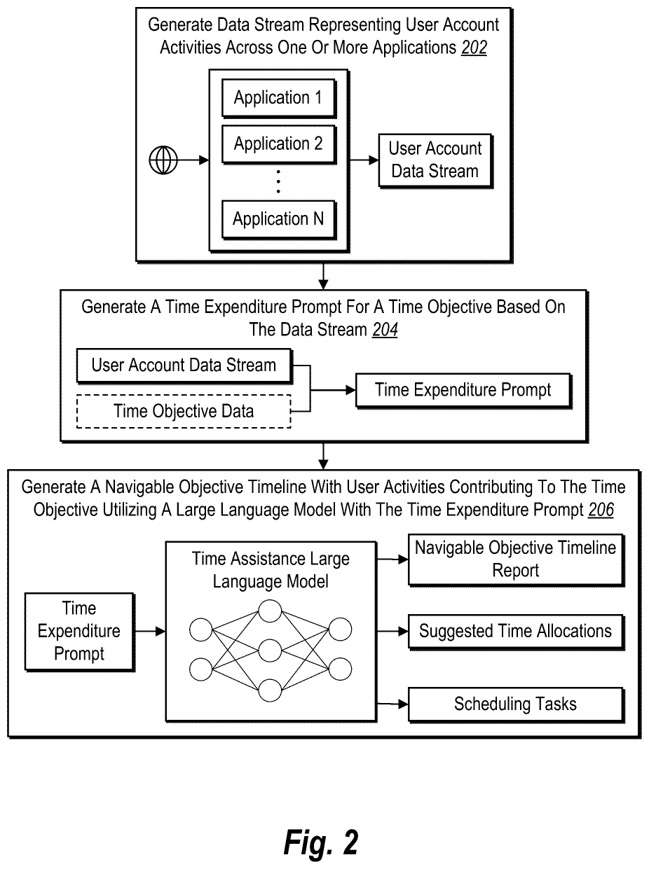

As mentioned above, the digital time objective assistant system 106 can utilize a large language model with user activity data to intelligently and automatically generate time objective timelines for user accounts. For instance, FIG. 2 illustrates an overview of the digital time objective assistant system 106 utilizing a large language model to generate time objective timelines from a generated time expenditure prompt. In particular, FIG. 2 illustrates the digital time objective assistant system 106 generating a data stream representing user account activities, generating a time expenditure prompt for a time object based on the data stream, and generating a navigable objective timeline utilizing a large language model with the time expenditure prompt.

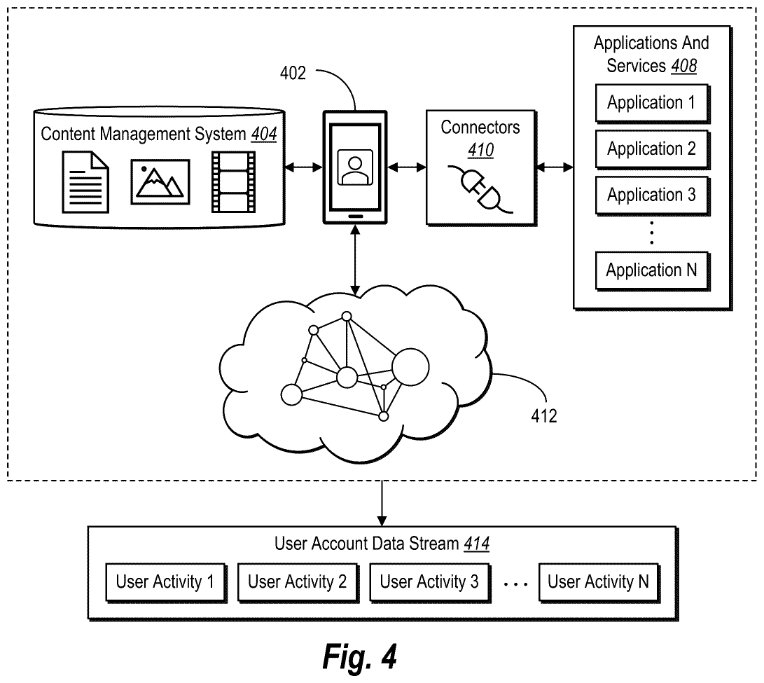

As shown in act 202 of FIG. 2, the digital time objective assistant system 106 generates a data stream representing user account activities across one or more applications. In one or more instances, the digital time objective assistant system 106 can identify various user account activities for a user account from a variety of applications utilized by the user account. Moreover, the digital time objective assistant system 106 can utilize the identified user account activities to generate a data stream that represents the user account activities across the applications. Indeed, the digital time objective assistant system 106 can generate a data stream of user account activities as described below (e.g., in reference to FIG. 4).

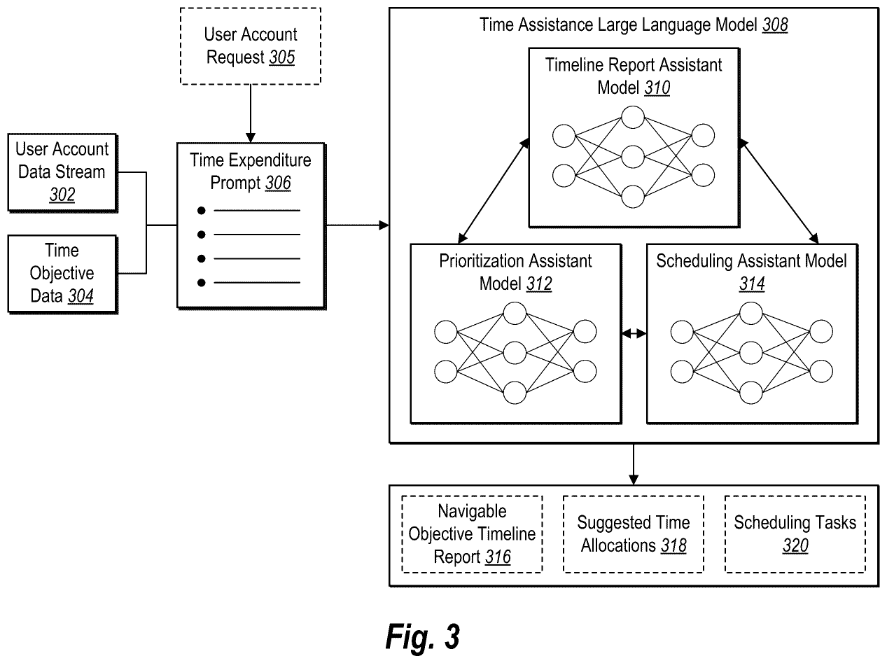

Additionally, as shown in act 204 of FIG. 2, the digital time objective assistant system 106 generates time expenditure prompt for a time objective based on the data stream. For instance, the digital time objective assistant system 106 utilizes user activities within a data stream and time objective data corresponding to a user account to generate a time expenditure prompt. Indeed, the time expenditure prompt can include user activity data descriptors and/or time objective descriptors for a user account to provide context specific to the user account for utilization in a large language model. In particular, the digital time objective assistant system 106 can generate a time expenditure prompt as described below (e.g., in reference to FIGS. 3 and 6-8).

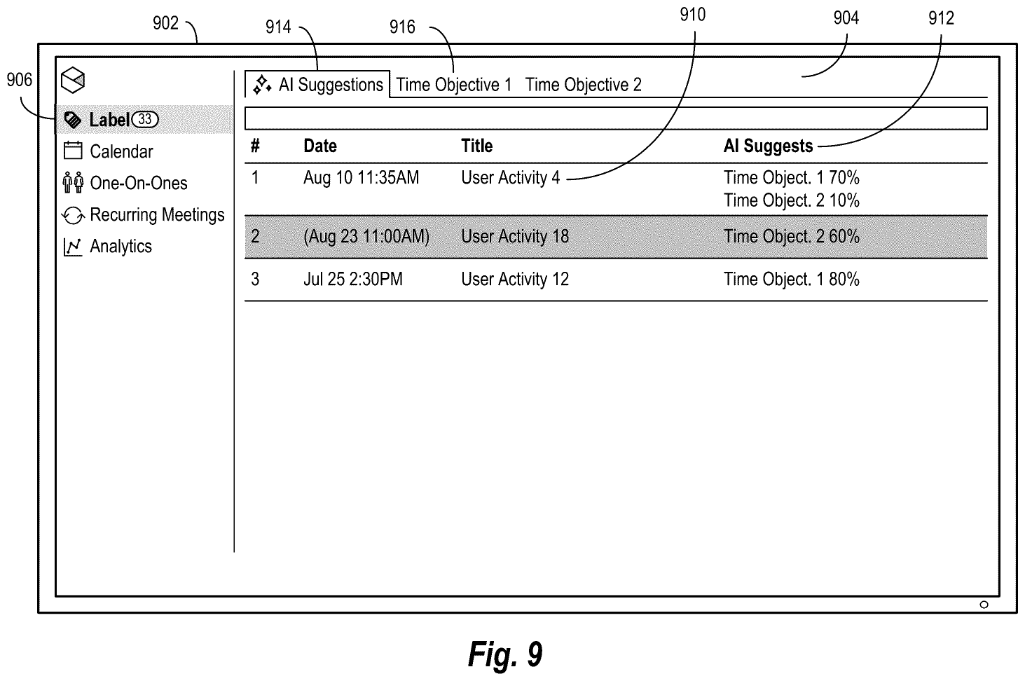

Furthermore, as shown in act 206 of FIG. 2, the digital time objective assistant system 106 generates a navigable objective timeline with user activities contributing to the time objective utilizing a large language model with the time expenditure prompt. For instance, the digital time objective assistant system 106 can utilize the time expenditure prompt with a time assistance large language model to generate a navigable objective timeline. To illustrate, as shown in FIG. 2, the digital time objective assistant system 106 can utilize the time assistance large language model to generate a navigable objective timeline report, generate suggested time allocations, and/or schedule tasks for a user account. In some cases, the digital time objective assistant system 106 can utilize a time assistance large language model having a timeline report assistant large language model, a prioritization assistant large language model, and/or a scheduling assistant large language model. Indeed, the digital time objective assistant system 106 can generate a navigable objective timeline utilizing a large language model with the time expenditure prompt as described below (e.g., in reference to FIGS. 3 and 6-8). Furthermore, the digital time objective assistant system 106 can also display various navigable objective timelines as described below (e.g., in reference to FIGS. 9-17).

Additionally, FIG. 3 illustrates an exemplary workflow of the digital time objective assistant system 106. For instance, FIG. 3 illustrates an exemplary workflow of the digital time objective assistant system 106 generating a time expenditure prompt. In addition, FIG. 3 also illustrates an exemplary workflow of the digital time objective assistant system 106 utilizing the time expenditure prompt with a time assistance large language model (e.g., having a variety of large language model components) to generate (or achieve) a variety of tasks (e.g., generating a navigable objective timeline report, generating suggested time allocations, scheduling tasks for a user account).

As shown in FIG. 3, the digital time objective assistant system 106 identifies a user account data stream 302 and time objective data 304. Indeed, as shown in FIG. 3, the digital time objective assistant system 106 utilizes the user account data stream 302 and the time objective data 304 to generate a time expenditure prompt 306. In some cases, the digital time objective assistant system 106 can also utilize a user account request 305 (e.g., a request for a report, a request for a time allocation recommendation, a request to schedule a calendar event) as part of the time expenditure prompt 306.

Furthermore, as shown in FIG. 3, the digital time objective assistant system 106 utilizes the time expenditure prompt 306 with a time assistance large language model 308 to generate a navigable objective timeline. Indeed, as shown in FIG. 3, the digital time objective assistant system 106 can utilize a time assistance large language model 308 that includes various large language model components. In particular, as shown in FIG. 3, the digital time objective assistant system 106 can utilize a timeline report assistant model 310 to generate a navigable objective timeline report 316 (as the navigable objective timeline) based on the time expenditure prompt 306. Moreover, as shown in FIG. 3, the digital time objective assistant system 106 can utilize a prioritization assistant model 312 to generate one or more suggested time allocations 318 (as the navigable objective timeline) based on the time expenditure prompt 306. In addition, as shown in FIG. 3, the digital time objective assistant system 106 can utilize a scheduling assistant model 314 to generate one or more scheduling tasks 320 (as the navigable objective timeline) based on the time expenditure prompt 306.

As also shown in FIG. 3, the digital time objective assistant system 106 can utilize the timeline report assistant model 310, the prioritization assistant model 312, and the scheduling assistant model 314 interdependently. In particular, the digital time objective assistant system 106 can utilize outputs of one or more of the timeline report assistant model 310, the prioritization assistant model 312, and the scheduling assistant model 314 as part of the time expenditure prompt (e.g., input) for the one or more of the timeline report assistant model 310, the prioritization assistant model 312, and the scheduling assistant model 314. For example, the large language model components can feed output data as input data into each other to generate the various navigable objective timeline outputs (as described herein).

As an example, the digital time objective assistant system 106 can utilize a time expenditure prompt with the timeline report assistant model 310 to generate a navigable objective timeline report 316. Indeed, the navigable objective timeline report 316 can include data (or summaries) of time spent by a user account on user activities for a time objective. Moreover, the digital time objective assistant system 106 can utilize a time expenditure prompt that includes the navigable objective timeline report 316 as input for the prioritization assistant model 312 to generate suggested time allocations 318 (e.g., time allocations that indicate or recommend an amount of time to spend on particular user activities for a time objective). Then, in one or more cases, the digital time objective assistant system 106 can utilize a time expenditure prompt that includes the suggested time allocations 318 as input for the scheduling assistant model 314 to generate scheduling tasks 320 (e.g., one or more electronic calendar events for user activities).

Although FIG. 3 illustrates separate components for the time assistance large language model, the digital time objective assistant system 106 can utilize a single (or combined) large language model to generate the various navigable objective timelines. For instance, the digital time objective assistant system 106 can utilize the time assistance large language model with one or more time expenditure prompts to generate the navigable objective timeline report, the suggested time allocations, and/or the scheduling tasks.

As mentioned above, the digital time objective assistant system 106 can generate (or identify) a data stream of user activities. For instance, FIG. 4 illustrates the digital time objective assistant system 106 identifying a data stream of user activities. In particular, FIG. 4 illustrates the digital time objective assistant system 106 identifying a data stream of user activities from user activities of a user account across various applications, services, user account relationships, and/or content item interactions corresponding to the user account.

For instance, as shown in FIG. 4, the digital time objective assistant system 106 can identify, for a user account corresponding to a computing device 402, various user activities within applications and services 408 via connectors 410. In particular, the digital time objective assistant system 106 can utilize the connectors 410 to extract data from user activity across various applications and services 408. As an example, the digital time objective assistant system 106 can extract data for user activities with a variety of applications, such as, but not limited to, messaging applications, calendaring applications, video call applications, notetaking applications, electronic communication applications, and/or digital content editing applications.

In addition, as shown in FIG. 4, the digital time objective assistant system 106 can also identify, for a user account corresponding to the computing device 402, various user interactions with digital content items of a digital content management system 404. As an example, the digital time objective assistant system 106 can identify one or more digital content items saved or associated with the user account. For instance, the digital time objective assistant system 106 can identify one or more digital content items associated with the user account, such as, but not limited to, electronic documents, project folders, digital images, and/or digital videos.

Moreover, as shown in FIG. 4, the digital time objective assistant system 106 can also utilize a knowledge graph 412. In particular, the digital time objective assistant system 106 can utilize a knowledge graph 412 that includes relationships between a user account, content items, applications, and/or one or more other user accounts. Indeed, the digital time objective assistant system 106 can utilize the knowledge graph 412 to identify user activities and/or content items that correspond to the user account.

In some cases, the digital time objective assistant system 106 can also identify multi-user activity histories. For instance, the digital time objective assistant system 106 can identify user account activities corresponding to projects and/or collaborations (e.g., time objectives) that involve multiple user accounts. Indeed, the digital time objective assistant system 106 can identify multi-user activities across various applications and services, digital content items, and/or knowledge graphs.

In some instances, the digital time objective assistant system 106 utilizes connectors to extract user activity data across one or more electronic applications corresponding to the user account as described in GENERATING AND MAINTAINING COMPOSITE ACTIONS UTILIZING LARGE LANGUAGE MODELS, U.S. patent application Ser. No. 18/478,061, filed Sep. 29, 2023.

In some implementations, the digital time objective assistant system 106 can also identify user activity data from the computing device 402. In particular, the digital time objective assistant system 106 can extract and/or utilize user activities (as described above) from a variety of applications (described above) from a computing device in which a user of a user account interacts to generate and/or establish the user activities (e.g., across one or more applications on the computing device). For instance, the digital time objective assistant system 106 can utilize user activity data corresponding to calendar events and/or messaging threads from within a computing device to generate a user account data stream.

Moreover, as shown in FIG. 4, the digital time objective assistant system 106 utilizes one or more of the identified user activities to generate a user account data stream 414. Indeed, the user account data stream 414 can include a collection of user activity data (e.g., user activity 1-N) for a user account across one or more applications and services 408. In addition, the user account data stream 414 can include user activities in relation to content items in a content management system 404. Moreover, the user account data stream 414 can include user activities corresponding to a user account based on relationships with one or more other user accounts and/or content items of other user accounts as indicated in the knowledge graph 412.

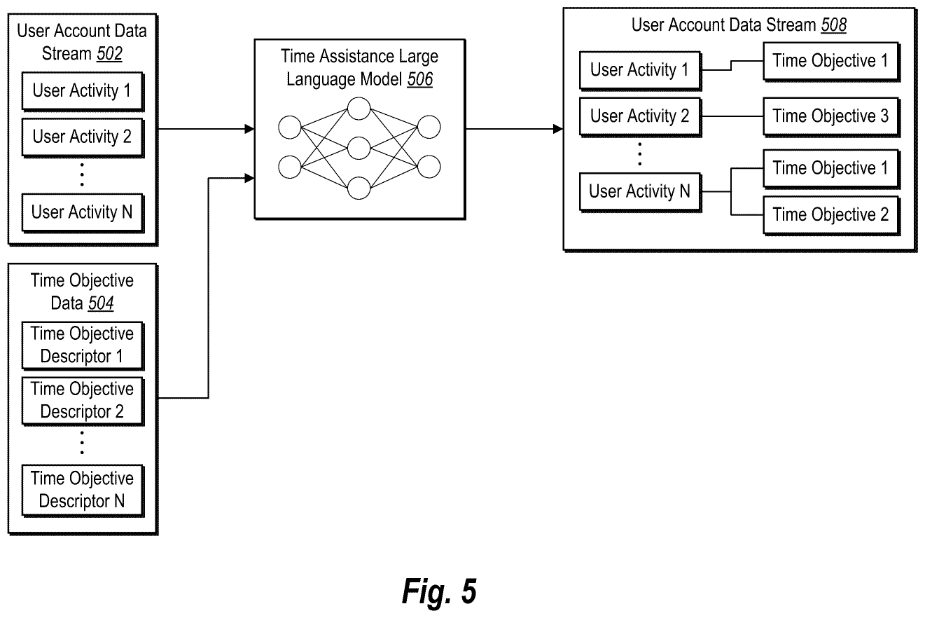

As mentioned above, the digital time objective assistant system 106 can tag one or more user activities with one or more time objectives. For instance, FIG. 5 illustrates the digital time objective assistant system 106 utilizing a time assistance large language model to tag a user activity utilizing time objective data. In particular, FIG. 5 illustrates the digital time objective assistant system 106 tagging one or more user activities with one or more time objectives corresponding to a user account.

As shown in FIG. 5, the digital time objective assistant system 106 identifies a user account data stream 502 that includes user activities 1-N. Indeed, the digital time objective assistant system 106 can identify a user account data stream 502 that includes user activities across one or more applications as described above. Moreover, the digital time objective assistant system 106 can also identify time objective data 504. Indeed, as shown in FIG. 5, the time objective data 504 includes descriptors for time objectives corresponding to the user account (e.g., time objective descriptors 1-N).

As further shown in FIG. 5, the digital time objective assistant system 106 can utilize the time objective data 504 (e.g., as descriptors that describe one or more attributes of time objectives corresponding to the user account) and the user account data stream 502 as part of a prompt for the time assistance large language model 506. As an example, the digital time objective assistant system 106 can generate a prompt that describes one or more time objectives (e.g., “project A includes users 1-N and relates to creating spreadsheets for travel expenses,” “project B includes users 1-N and relates to creating a movie poster for movie A”). In addition, the digital time objective assistant system 106 can generate the prompt to include the user account data stream 502. As shown in FIG. 5, the digital time objective assistant system 106 provides the user account data stream 502 and the time objective data 504 (as a prompt) to the time assistance large language model 506 with a request to identify relationships between the time objectives and the user activities.

In response, as shown in FIG. 5, the time assistance large language model 506 generates (or determines) tags for the one or more user activities in the user account data stream. Indeed, as shown in FIG. 5, the time assistance large language model 506 tags individual user activities with one or more time objectives (within a user account data stream 508). As illustrated in FIG. 5, the digital time objective assistant system 106 can tag user activities with one or more time objectives. Furthermore, as shown in FIG. 5, the digital time objective assistant system 106 can tag multiple user activities with similar time objectives.

In some instances, the digital time objective assistant system 106 also determines or generates tag scores for the tagged user activities. For instance, the digital time objective assistant system 106 can utilize a machine learning model (e.g., a classification model or a large language model) to determine confidence scores (or probability) scores for one or more time objectives in relation to a user activity. For example, the digital time objective assistant system 106 can generate, for a user activity, a tag for a first time objective with a first tag score and a tag for a second time objective with a second tag score to indicate which time objective is more likely related to the user activity.

As an example, the digital time objective assistant system 106 can identify an electronic calendar event as a user activity. Indeed, the digital time objective assistant system 106 can utilize the time assistance large language model to analyze, via the input prompt, descriptors of the time objectives and descriptors or attributes of the electronic calendar event (e.g., user accounts, topics, titles, project names, timing) to determine a time objective that is relevant to the electronic calendar event. For instance, the digital time objective assistant system 106 can determine that an electronic calendar event that mentions project A (e.g., a time objective) as relevant for project A. As another example, the digital time objective assistant system 106 can determine that an electronic calendar event that is associated with content items corresponding to project A (e.g., a time objective) as relevant for project A.

As another example, the digital time objective assistant system 106 can identify an email thread as a user activity. Moreover, the digital time objective assistant system 106 can utilize the time assistance large language model to analyze, via the input prompt, descriptors of the time objectives and descriptors or attributes of the email thread to determine a time objective that is relevant to the email thread. For instance, the digital time objective assistant system 106 can determine that an email thread that mentions project A (e.g., a time objective) as relevant for project A.

In some cases, the digital time objective assistant system 106 utilizes historical user activities to tag user activities with time objective data. For instance, the digital time objective assistant system 106 can identify historical user activity data that is tagged or associated with a time objective to learn time objective and user activity relevancies (e.g., via titles, content, or activity patterns). Then, the digital time objective assistant system 106 can utilize the learned relevancies between time objectives and historical user activities to generate (or determine) tags for the one or more user activities in the user account data stream. In some implementations, the digital time objective assistant system 106 utilizes historical user activity data tagged by one or more users with one or more time objective tags.

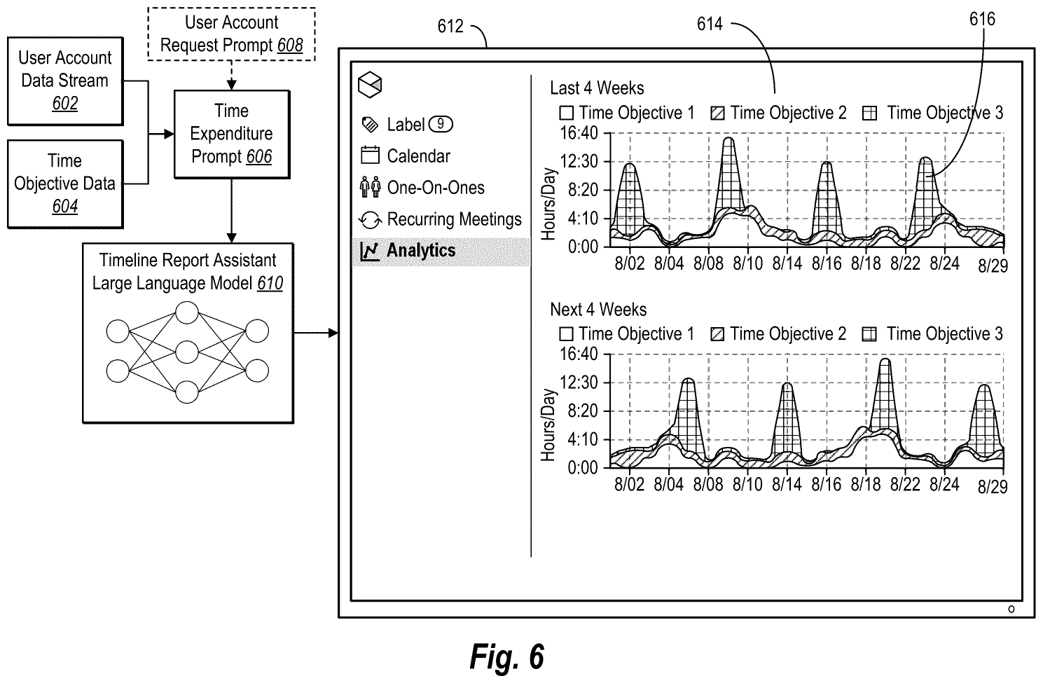

As mentioned above, the digital time objective assistant system 106 can generate a navigable objective timeline that indicates a timeline report for one or more time objectives via user activities of a user account. For instance, FIG. 6 illustrates the digital time objective assistant system 106 utilizing a timeline report assistant large language model to generate a navigable objective timeline report (as the navigable objective timeline).

As shown in FIG. 6, the digital time objective assistant system 106 can generate a time expenditure prompt 606 from a user account data stream 602 and time objective data 604. Indeed, the digital time objective assistant system 106 can utilize a user account data stream 602 that includes user activities of a user account across one or more applications (as described above). Furthermore, the digital time objective assistant system 106 can utilize time objective data 604 that includes descriptors for one or more time objectives corresponding to the user account. Indeed, the digital time objective assistant system 106 can convert the time objective data 604 and the user account data stream 602 into a time expenditure prompt 606 (e.g., an input text format that describes the user activities and/or the time objectives for the user account). In some cases, the time objective data 604 can also include descriptors to indicate priorities for time objectives (e.g., priority flags and/or rankings).

Additionally, in some cases, the digital time objective assistant system 106 can also receive a user account request prompt 608. Indeed, in one or more instances, the user account request prompt 608 can include a user provided text prompt that indicates a command or request for the timeline report assistant large language model 610. As an example, the user account request prompt 608 can indicate text prompts, such as, “generate a time objective summary report,” “generate a user activity time summary,” and/or “compare user activity stats between a time objective A and a time objective B.” Indeed, the digital time objective assistant system 106 can append (or combine) the user account request prompt 608 with the time expenditure prompt 606 (e.g., which includes user activity data and/or time objective descriptors).

As further shown in FIG. 6, the digital time objective assistant system 106 utilizes the time expenditure prompt 606 with a timeline report assistant large language model 610 to generate a navigable objective timeline that indicates a timeline report for one or more time objectives via user activities of a user account. For instance, the digital time objective assistant system 106 can generate time summaries that indicate time usage across one or more time objectives (e.g., an amount of time spent on a particular time objective). In addition, the digital time objective assistant system 106 can generate a timeline report that indicates user activities or types of user activities corresponding to one or more time objectives. In some cases, the digital time objective assistant system 106 can generate a timeline report to indicate user priorities on one or more time objectives (e.g., a comparison or indication of which time objective is getting prioritized by a user based on identified user activities).

As an example, FIG. 6 illustrates the digital time objective assistant system 106 generating and displaying a timeline report that indicates an amount of time spent across one or more time objectives (based on the time expenditure prompt 606). For instance, as shown in FIG. 6, the digital time objective assistant system 106 provides for display, within a graphical user interface 614 of a client device 612, a timeline report 616. Indeed, as shown in the timeline report 616, the digital time objective assistant system 106 can display an amount of time spent by a user across various time objectives based on an analysis of the user account data stream 602 and the time objective data 604 by the timeline report assistant large language model 610 (via the time expenditure prompt 606). Indeed, in one or more instances, the digital time objective assistant system 106 can generate a timeline report as, but not limited to, a text based output, a visual output (e.g., a chart, an image, a video), and/or a spreadsheet output.

In some cases, the digital time objective assistant system 106 trains (or learns parameters of) the timeline report assistant large language model to utilize input data (e.g., user activities and/or time objective descriptors) to generate timeline reports, comparisons, and/or tags. Indeed, in some embodiments, the digital time objective assistant system 106 can utilize historical user activities and time objectives with ground truth timeline reports to train the timeline report assistant large language model.

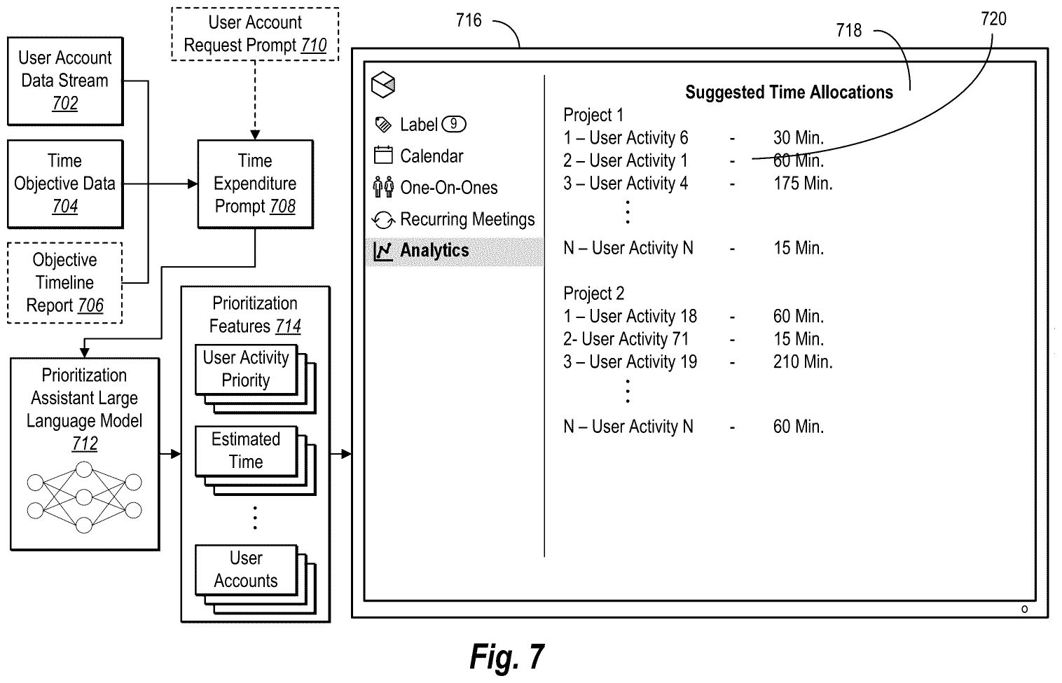

As mentioned above, the digital time objective assistant system 106 can generate a navigable objective timeline that indicates time allocation suggestions for a user account. For instance, FIG. 7 illustrates the digital time objective assistant system 106 utilizing a prioritization assistant large language model to generate a time allocation suggestion (as the navigable objective timeline).

As shown in FIG. 7, the digital time objective assistant system 106 can generate a time expenditure prompt 708 from a user account data stream 702 and time objective data 704. Indeed, the digital time objective assistant system 106 can convert the time objective data 704 and the user account data stream 702 into a time expenditure prompt 708 (e.g., an input text format that describes the user activities and/or the time objectives for the user account) in accordance with one or more implementations herein. Furthermore, in some cases, the digital time objective assistant system 106 can also utilize an objective timeline report 706 (as described above) to generate the time expenditure prompt 708 (e.g., generating a prompt that describes or represents user activity data, time objective descriptors, and objective timeline reports).

Additionally, in some cases, the digital time objective assistant system 106 can also receive a user account request prompt 710. For example, the user account request prompt 710 can include a user provided text prompt that indicates a command or request for the prioritization assistant large language model 712. As an example, the user account request prompt 710 can include text prompts, such as, “determine user activity priorities for time objective A,” “recommend a time allocation for tasks in time objective A and time objective B,” and/or “compare user activity stats between a time objective A and a time objective B.” Indeed, the digital time objective assistant system 106 can append (or combine) the user account request prompt 710 with the time expenditure prompt 708 (e.g., which includes user activity data, time objective descriptors, and/or objective timeline reports).

As also shown in FIG. 7, the digital time objective assistant system 106 utilizes the time expenditure prompt 708 with the prioritization assistant large language model 712 to generate a navigable objective timeline that that indicates time allocation suggestions for a user account. For example, as shown in FIG. 7, the digital time objective assistant system 106 can utilize the prioritization assistant large language model 712 to generate prioritization features 714. Indeed, the prioritization features 714 can include determined user activity priorities, estimated times for the user activities, and/or user accounts associated with a user activity and/or time objective. Furthermore, as shown in FIG. 7, the digital time objective assistant system 106 can utilize the prioritization assistant large language model 712 to provide, for display within a graphical user interface 718 of a client device 716, suggested time allocations 720 for one or more time objectives (e.g., Project 1 and Project 2). Indeed, as shown in FIG. 7, the digital time objective assistant system 106 displays user activities to prioritize (with estimated times) for the time objectives (e.g., Project 1 and Project 2). In particular, as shown in FIG. 7, the digital time objective assistant system 106 can display priorities for user activities and time allocations for user activities for one or more of the time objectives based on utilizing the time expenditure prompt 708 with the prioritization assistant large language model 712. Indeed, the digital time objective assistant system 106 can generate a variety of time allocation suggestions to indicate (or plan) user activities for a user account to accomplish or complete a time objective (e.g., plan a roadmap of activities to complete ordered by priority and/or estimated times).

For example, the digital time objective assistant system 106 can utilize the time expenditure prompt 708 with the prioritization assistant large language model to determine user activity priorities (as the prioritization features 714). In particular, the digital time objective assistant system 106 can determine one or more user activities to prioritize in order to accomplish a time objective. In some instances, the digital time objective assistant system 106 can determine, from multiple time objectives, a time objective to prioritize. Subsequently, the digital time objective assistant system 106 can determine user activities for the time objective to prioritize. Moreover, the digital time objective assistant system 106 can also determine an order in which to prioritize user activities to enable the completion of a time objective.

Furthermore, the digital time objective assistant system 106 can also utilize the time expenditure prompt 708 with the prioritization assistant large language model 712 to determine estimated times for user activities (as the prioritization features 714). For example, the digital time objective assistant system 106 can determine estimated times to complete one or more of the user activities corresponding to a user account. As an example, the digital time objective assistant system 106 can utilize the user account data stream 702 data within the time expenditure prompt 708 to analyze and determine times spent by a user of the user account on various user account activities to determine estimated times for one or more of the user activities corresponding to a user account. Indeed, the digital time objective assistant system 106 can utilize the estimated times to determine user activity prioritizations and/or suggested time allocations for one or more time objectives.

Moreover, the digital time objective assistant system 106 can also utilize the time expenditure prompt 708 with the prioritization assistant large language model 712 to determine user accounts corresponding to user activities (as the prioritization features 714). For instance, the digital time objective assistant system 106 can determine one or more user accounts involved in a user activity (or a time objective corresponding to the user activity). Additionally, the digital time objective assistant system 106 can utilize user activity data corresponding to the user accounts to determine suggested time allocations, estimated times, and/or user account priorities for one or more time objectives.

Additionally, the digital time objective assistant system 106 can generate time allocation suggestions for multiple time objectives (and/or single time objectives). In particular, the digital time objective assistant system 106 can generate time allocation suggestions that compare user activity allocations (or priorities) between time objectives. In addition, the digital time objective assistant system 106 can also utilize data streams of user activities from multiple user accounts to generate time allocations suggestions that account for multiple user account user activities (e.g., calendar events for multiple user accounts), priorities, and/or schedules in accordance with one or more implementations.

In one or more instances, the digital time objective assistant system 106 can display generated time allocation suggestions within an electronic calendar graphical user interface and/or a timeline graphical user interface. Indeed, the digital time objective assistant system 106 can also display the time allocation suggestions within graphical user interface elements that are interactive (e.g., scrollable, moveable) to demonstrate the time allocation suggestions within an electronic calendar graphical user interface and/or a timeline graphical user interface. For example, the digital time objective assistant system 106 can display one or more time allocation suggestions by positioning the user activity time allocations at particular times and dates within a graphical user interface.

In some instances, the digital time objective assistant system 106 trains (or learns parameters of) the prioritization assistant large language model to utilize input data (e.g., user activities and/or time objective descriptors) to generate time allocation suggestions and/or other prioritization features as described herein. Indeed, in some embodiments, the digital time objective assistant system 106 can utilize historical user activities and time objectives with ground truth prioritizations and/or time allocations to train the prioritization assistant large language model.

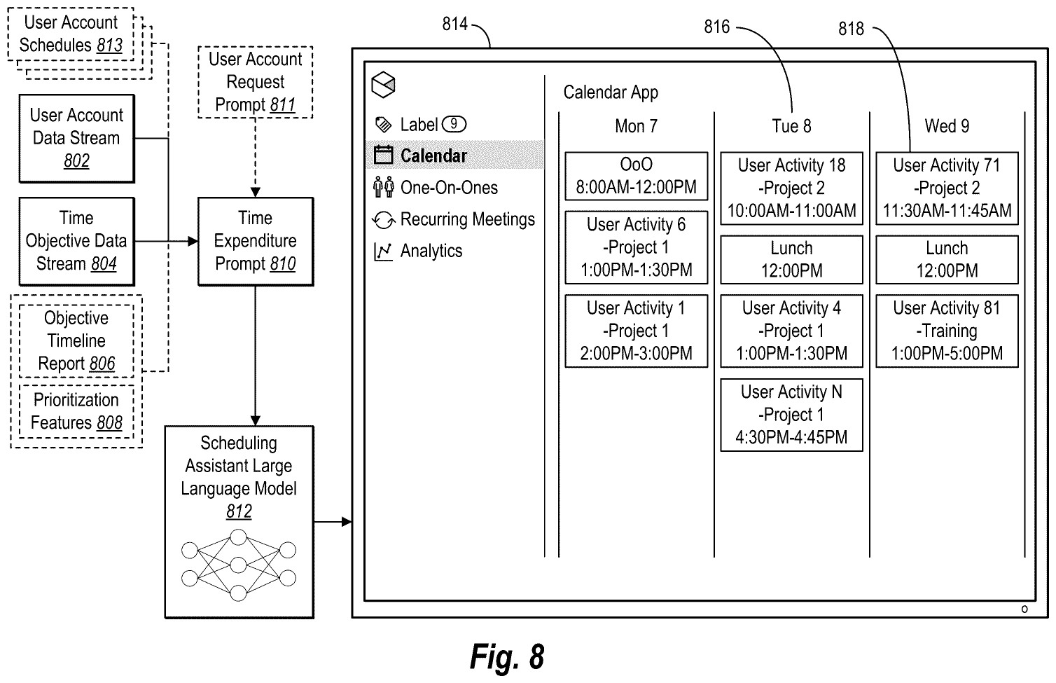

As mentioned above, the digital time objective assistant system 106 can generate a navigable objective timeline by generating an electronic calendar event for a user account. For instance, FIG. 8 illustrates the digital time objective assistant system 106 utilizing a scheduling assistant large language model to schedule tasks or generate electronic calendar events (as the navigable objective timeline).

As shown in FIG. 8, the digital time objective assistant system 106 can generate a time expenditure prompt 810 from a user account data stream 802 and time objective data 804. Indeed, the digital time objective assistant system 106 can convert the time objective data 804 and the user account data stream 802 into the time expenditure prompt 810 in accordance with one or more implementations herein. Additionally, in some instances, the digital time objective assistant system 106 can also utilize an objective timeline report 806 (as described above) and/or prioritization features 808 (as described above) to generate the time expenditure prompt 810.

Moreover, the digital time objective assistant system 106 can also receive a user account request prompt 811. For instance, the digital time objective assistant system 106 can include a user provided text prompt that indicates a command or request for the scheduling assistant large language model 812. As an example, the user account request prompt 811 can include text prompts, such as, “schedule a meeting for time objective A with user A and user B,” “scheduling my calendar for time objective A based on the time allocation suggestions for time objective A,” “schedule user activities for time objective A using the prioritizations determined for the time objective,” and/or “schedule user activities to accomplish time objective A by time A.” Indeed, the digital time objective assistant system 106 can append (or combine) the user account request prompt 811 with the time expenditure prompt 810 (e.g., which includes user activity data, time objective descriptors, objective timeline reports, and/or prioritization features).

Indeed, the digital time objective assistant system 106 can utilize the scheduling assistant large language model 812 with the time expenditure prompt 810 (as described above) to generate or schedule one or more electronic calendar events. In particular, the scheduling assistant large language model 812 can generate one or more electronic calendar events that indicate one or more user activities and/or time objectives. Furthermore, the scheduling assistant large language model 812 can generate the one or more electronic calendar events that also invite or include one or more user accounts corresponding to the particular one or more user activities and/or time objectives. Additionally, the scheduling assistant large language model 812 can generate the one or more electronic calendar events to include (as attachments) one or more content items corresponding to the particular one or more user activities and/or time objectives.

Indeed, as shown in FIG. 8, the digital time objective assistant system 106 provides, for display within an electronic calendar user interface 816 of a client device 814, a generated electronic calendar event 818 based on the time expenditure prompt 810. As shown in FIG. 8, the electronic calendar event 818 can include a user activity identifier. Moreover, as shown in FIG. 8, the electronic calendar event 818 can also include a time objective identifier.

In addition, as mentioned above, the digital time objective assistant system 106 can generate one or more electronic calendar events to match a time allocation suggestion for user activities and/or a time objective (as included in a time expenditure prompt). For instance, the digital time objective assistant system 106 can schedule user activities for a user account to follow (or match) user activity priorities determined in accordance with one or more implementations herein. In addition, the digital time objective assistant system 106 can schedule user activities for a user account to follow (or match) a time allocation for user activities to complete or achieve one or more time objectives (determined in accordance with one or more implementations herein).

In one or more instances, the digital time objective assistant system 106 can also utilize user account schedules 813 to generate a time expenditure prompt 810. In particular, the digital time objective assistant system 106 can include one or more user account schedules 813 within the time expenditure prompt 810 to generate electronic calendar events that account for schedules (or events) corresponding to the one or more user accounts. Indeed, the digital time objective assistant system 106 can utilize the scheduling assistant large language model 812 to generate electronic calendar events that account for one or more user account schedules (e.g., a particular user account and/or one or more collaborating user accounts).

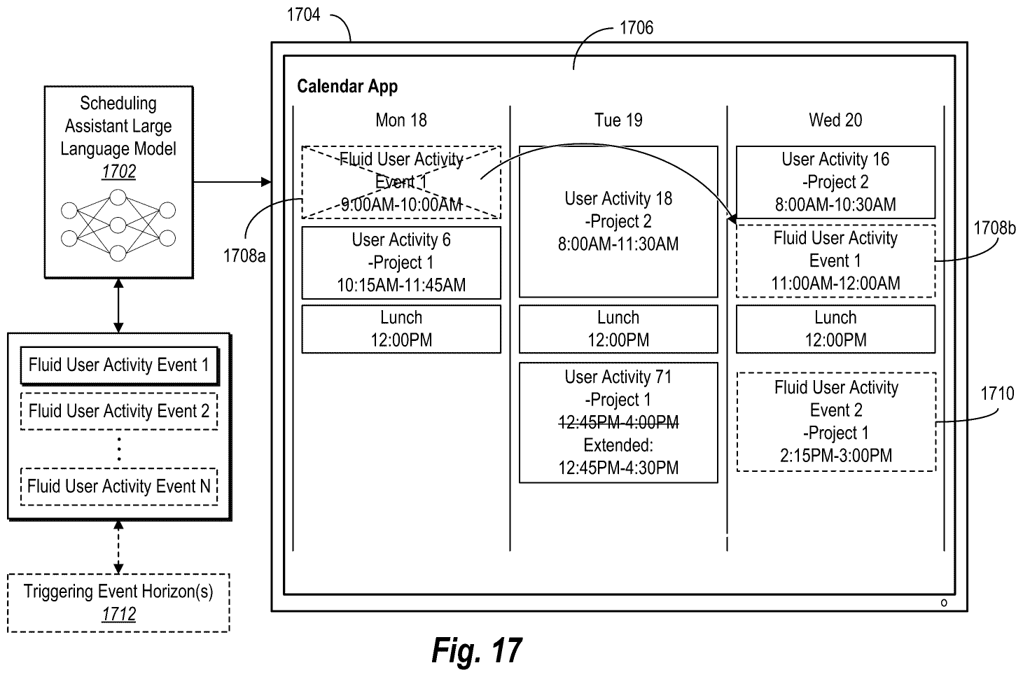

In some cases, the digital time objective assistant system 106 can also utilize the scheduling assistant large language model 812 to generate a fluid user activity event. Indeed, the digital time objective assistant system 106 can further utilize the scheduling assistant large language model 812 to monitor a user account electronic calendar to modify an electronic calendar event corresponding to a fluid user activity event based on changes to the electronic calendar of a user account. Indeed, the digital time objective assistant system 106 can generate and utilize a fluid user activity event as described below (e.g., in reference to FIG. 17).

As mentioned above, the digital time objective assistant system 106 can display various navigable objective timelines generated in accordance with one or more implementations herein. For instance, FIGS. 9-17 illustrate the digital time objective assistant system 106 displaying graphical user interfaces with various navigable objective timelines generated utilizing a large language model (as described above). For instance, FIGS. 9-17 illustrate the digital time objective assistant system 106 displaying various navigable objective timeline reports, suggested time allocations (or other prioritization features), and/or scheduled electronic calendar events or tasks.

For instance, FIG. 9 illustrates the digital time objective assistant system 106 displaying time objective tags for one or more user activities (determined in accordance with one or more implementations herein). For instance, as shown in FIG. 9, the digital time objective assistant system 106 provides for display, within a graphical user interface 904 of a client device 902, an objective timeline report that indicates user activities and time objective tags for the user activities (in response to a selection of a tab 906 for labels). Indeed, as shown in FIG. 9, the digital time objective assistant system 106 displays a user activity 910 corresponding to a user account and suggested time objective tags 912 for the user activity 910, determined as described above. As also shown in FIG. 9, the digital time objective assistant system 106 also displays a time objective tag score for the time objective tags 912.

Furthermore, the digital time objective assistant system 106 can also display a selectable element 914 to view time objective tags determined utilizing a time assistant large language model in accordance with one or more implementations herein (e.g., as shown in the graphical user interface 904). In addition, the digital time objective assistant system 106 can also display a selectable element 916 to enable a display of user activities organized by a particular tag (e.g., time objective 1, time objective 2).

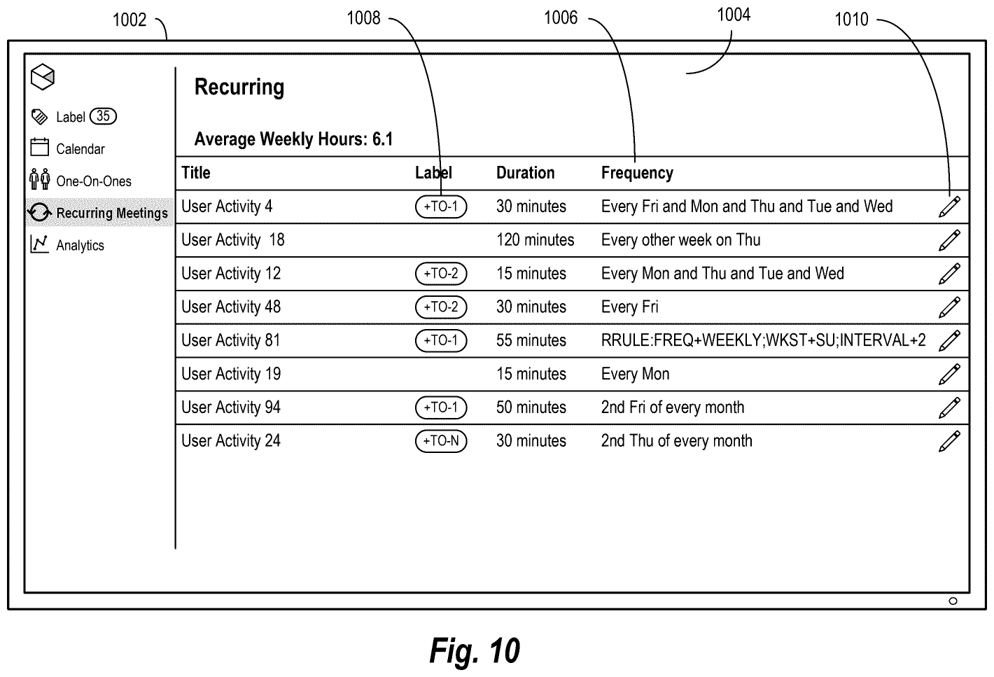

Furthermore, FIG. 10 illustrates the digital time objective assistant system 106 displaying user activities categorized by an activity occurrence type. In particular, the digital time objective assistant system 106 can determine, for one or more user activities, an activity occurrence category (e.g., a one-on-one activity between users, a recurring user activity, a one-time user activity). In some cases, the digital time objective assistant system 106 determine the activity occurrence category by analyzing a data stream of user activities (for a user account) utilizing a large language model in accordance with one or more implementations herein.

Furthermore, as shown in FIG. 10, the digital time objective assistant system 106 provides, for display within a graphical user interface 1004 of a client device 1002, summary 1006 of user activities organized by an activity occurrence category (e.g., recurring user activities). As also shown in FIG. 10, the digital time objective assistant system 106 also displays time objective tags 1008 corresponding to the user activities (determined in accordance with one or more implementations herein). Additionally, as shown in FIG. 10, the digital time objective assistant system 106 displays a duration and a frequency of the user activities. Although FIG. 10 illustrates the digital time objective assistant system 106 displaying user activities for an activity occurrence category of recurring user activities, the digital time objective assistant system 106 can display user activities for a variety of activity occurrence categories (e.g., one-on-one activities, one-time activities). Indeed, in some cases, the activity occurrence categories can indicate an occurrence frequency for an electronic calendar event (e.g., one-on-one meeting, one-time meeting, recurring meeting).

In some instances, the digital time objective assistant system 106 can also enable modifications to an objective timeline report. For instance, as shown in FIG. 10, the digital time objective assistant system 106 displays a selectable element 1010 to enable modification of one or more elements of a user activity within an objective timeline report. For instance, the digital time objective assistant system 106 can facilitate modification of time objective tags, estimated durations, and/or frequencies of a user activity displayed by the digital time objective assistant system 106.

In some cases, the digital time objective assistant system 106 can utilize a time expenditure prompt that includes user activity data from a user account data stream with a timeline report assistant large language model to generate a variety of statistics for user activities corresponding to a user account. For instance, the digital time objective assistant system 106 can determine statistics for user activities, such as, but not limited to, attendance statistics, cancellation statistics, completion statistics, deadline statistics, and/or modification statistics.

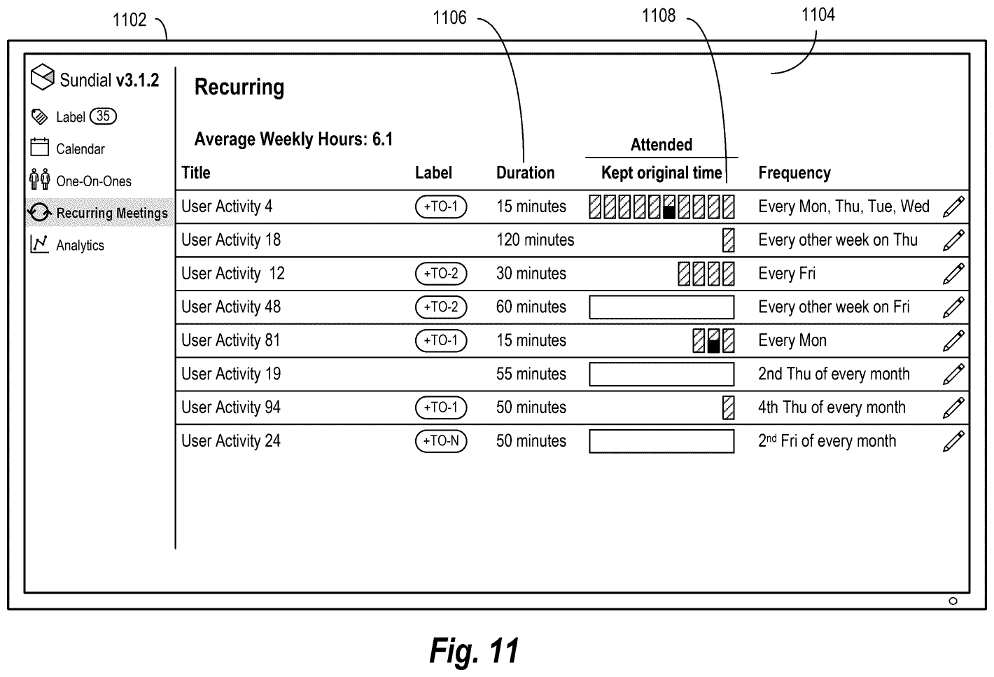

For instance, FIG. 11 illustrates the digital time objective assistant system 106 determining and displaying user activity statistics generated by a large language model utilizing a time expenditure prompt. Indeed, as shown in FIG. 11, the digital time objective assistant system 106 provides, for display within a graphical user interface 1104 of a client device 1102, an objective timeline report 1106 to indicate a summary of attendance statistics 1108 for user activities (e.g., user activity calendar events) to indicate whether user activities were attended or modified (e.g., kept original time). Indeed, in one or more instances, the digital time objective assistant system 106 analyzes user activities from a user account data stream to determine the summary of attendance statistics as an objective timeline report using a large language model in accordance with one or more implementations herein.

Furthermore, the digital time objective assistant system 106 can display a variety of objective timeline reports in various formats, such as, but not limited to, numerical statistics, charts, and/or other visualizations. Additionally, the digital time objective assistant system 106 can determine and display a variety of objective timeline reports for historical user activities and/or future user activities (e.g., scheduled and/or predicted user activities).

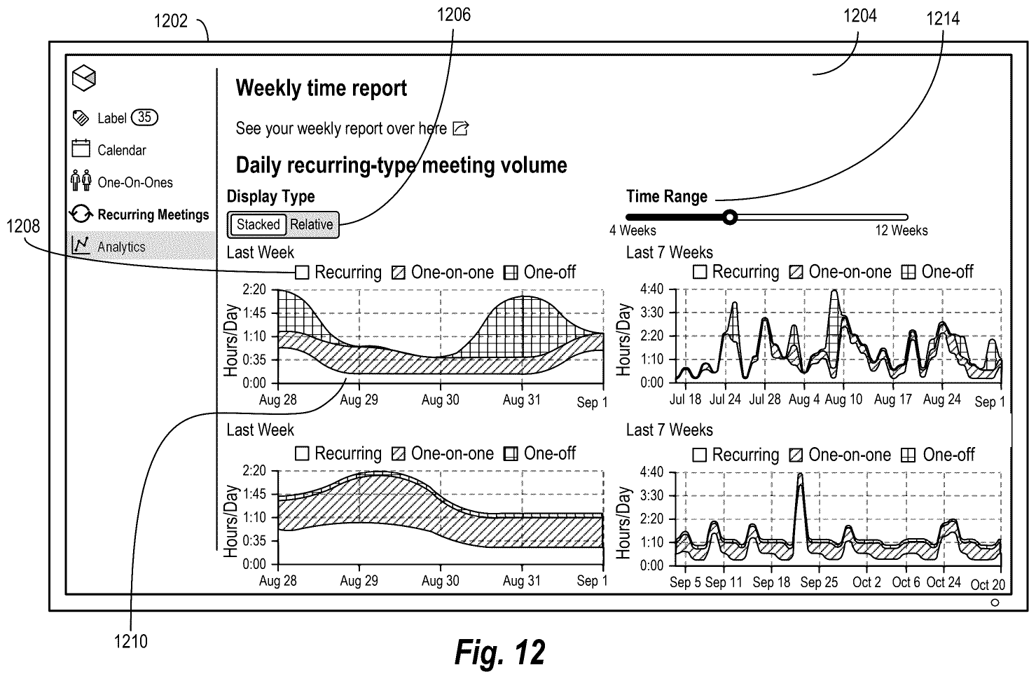

As an example, the digital time objective assistant system 106 can generate an objective timeline report (utilizing a large language model in accordance with one or more implementations herein) to indicate a summary of time spent on various user activities according to an activity occurrence category type. Indeed, as shown in FIG. 12, the digital time objective assistant system 106 provides, for display within a graphical user interface 1204 of a client device 1202, an objective timeline report 1210 indicating an amount of time spent on user activities based on activity occurrence category types 1208. In particular, as shown in FIG. 12, the digital time objective assistant system 106 can display hours per day spent by a user account on user activities corresponding to particular activity occurrence category types 1208 within the objective timeline report 1210.

Additionally, the digital time objective assistant system 106 can provide one or more selectable options within a navigable objective timeline graphical user interface to modify a display of an objective timeline report and/or a data range for an objective timeline report. For instance, as shown in FIG. 12, the digital time objective assistant system 106 displays a selectable element 1206 to switch between a display type for the objective timeline report 1210 (e.g., a stacked graph or a relative graph). Upon receiving a user interaction with the selectable element 1206, the digital time objective assistant system 106 can modify the displayed objective timeline report 1210 to display the objective timeline report 1210 as a stacked graph versus a relative graph. Indeed, the digital time objective assistant system 106 can display the objective timeline report 1210 in a variety of formats, such as, but not limited to, bar graphs, pie charts, numerical statistics, and/or spreadsheets.

Furthermore, as shown in FIG. 12, the digital time objective assistant system 106 can also display a time range selection element 1214 (e.g., as a slider element). Indeed, the digital time objective assistant system 106 can enable a user to select a time range for an objective timeline report. For instance, based on a selection of a time range (e.g., 4 weeks, 7 weeks, 10 weeks, 12 weeks), the digital time objective assistant system 106 can generate an objective timeline report based on the time range (by including the time range in the time expenditure prompt) in accordance with one or more implementations herein. Although FIG. 12 illustrates the digital time objective assistant system 106 displaying a slider tool element, the digital time objective assistant system 106 can display various selectable user interface elements (e.g., radio buttons, dropdown menus) to select time ranges and/or other options for a time expenditure prompt to generate and display a customized objective timeline report (in accordance with one or more implementations herein).

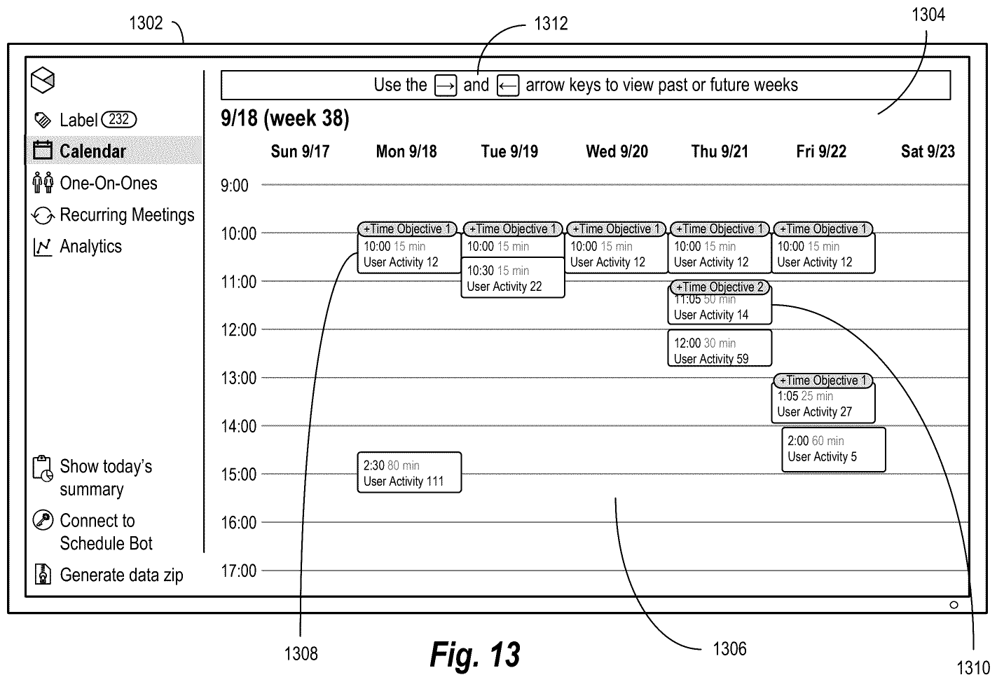

In addition, FIG. 13 illustrates the digital time objective assistant system 106 displaying electronic calendar events (as user activities) with time objective tags determined in accordance with one or more implementations herein. For instance, as shown in FIG. 13, the digital time objective assistant system 106 provides, for display within a graphical user interface 1304 of a client device 1302, an electronic calendar interface 1306. Indeed, as shown in FIG. 13, the digital time objective assistant system 106 displays a user activity 1308 within the electronic calendar interface 1306 with a determined time objective tag for the user activity 1308 (e.g., a time objective 1). Moreover, as shown in FIG. 13, the digital time objective assistant system 106 also displays a user activity 1310 within the electronic calendar interface 1306 with a determined time objective tag for the user activity 1310 (e.g., a time objective 2). Indeed, the digital time objective assistant system 106 can display various user activities within an electronic calendar interface with a various number of time objective tags.

Additionally, as shown in FIG. 13, the digital time objective assistant system 106 also displays a selectable element 1312 to navigate within the electronic calendar interface 1306. Indeed, the digital time objective assistant system 106 can receive a user interaction with the selectable element 1312 to view past and/or future dates within the electronic calendar interface 1306. In response, the digital time objective assistant system 106 displays different time periods in the electronic calendar interface 1306 with corresponding user activities and time objective tags for the user activities.

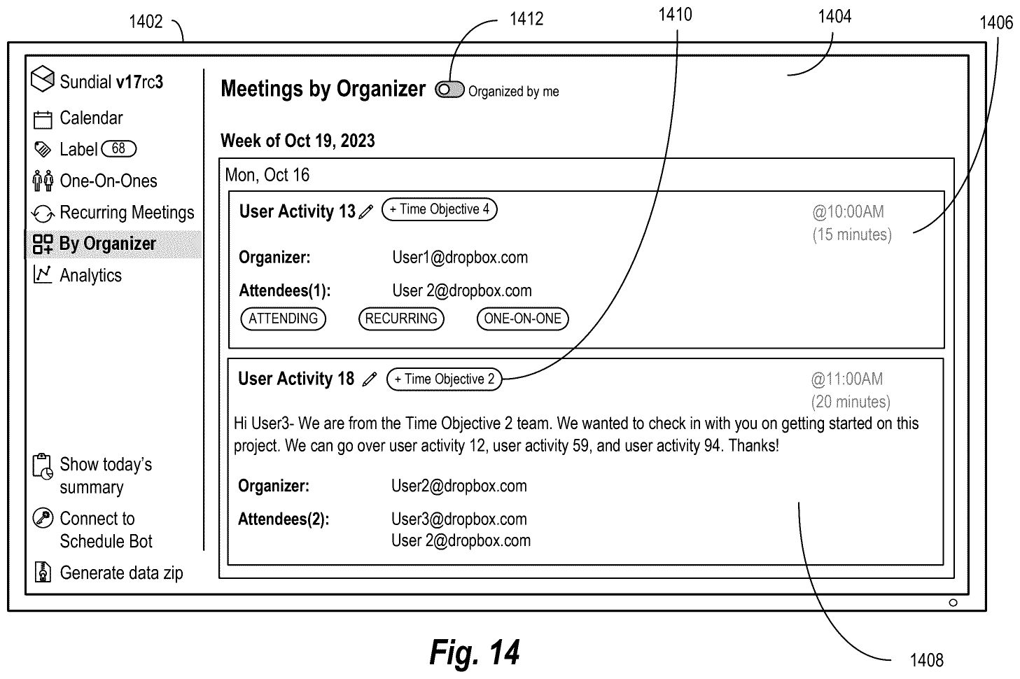

Furthermore, FIG. 14 illustrates the digital time objective assistant system 106 displaying calendar event user activities organized by a creator (or organizer) for the calendar event user activities. For instance, as shown in FIG. 14, the digital time objective assistant system 106 provides, for display within a graphical user interface 1404 of a client device 1402, a user activity 1406 indicating a creator (e.g., organizer) and attendees and activity occurrence categories. In addition, as shown in FIG. 14, the digital time objective assistant system 106 also displays a user activity 1408 indicating a creator (e.g., organizer) and attendees, information for the user activity 1408, and a time objective tag 1410. Furthermore, the digital time objective assistant system 106 also displays a selectable element 1412 to filter user activities to display user activities created by a current user account. Indeed, upon receiving a user interaction with the selectable element 1412, the digital time objective assistant system 106 can display one or more user activities created by the user account.

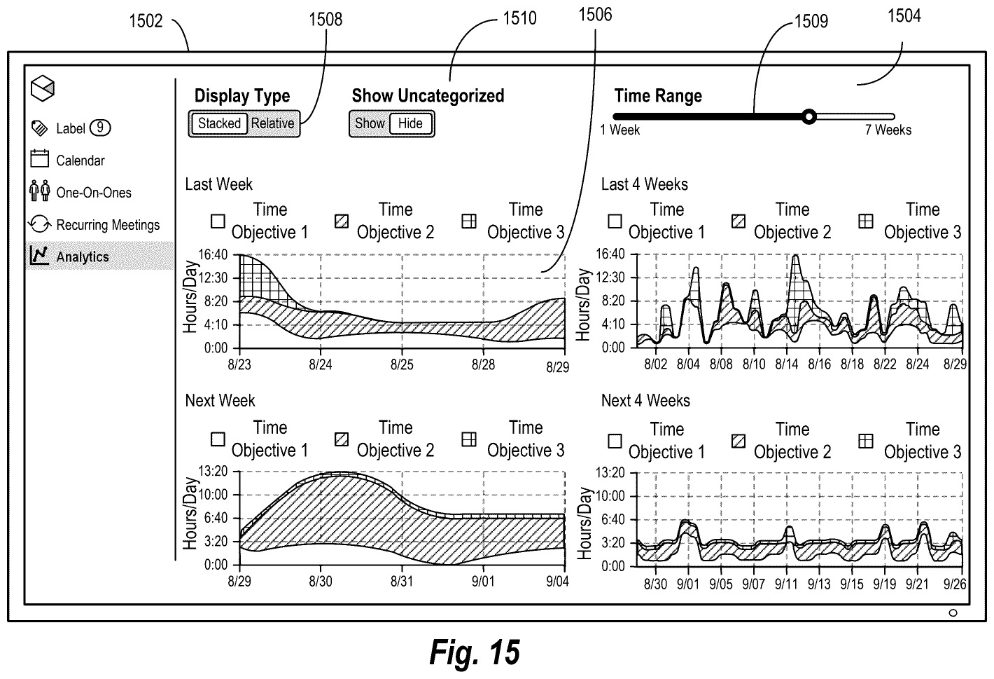

Moreover, the digital time objective assistant system 106 can generate an objective timeline report (utilizing a large language model in accordance with one or more implementations herein) to indicate a summary of time spent on various user activities according to time objective tags. For instance, FIG. 15 illustrates the digital time objective assistant system 106 displaying an objective timeline report to summarize time spent on user activities according to time objectives. Indeed, the digital time objective assistant system 106 can utilize a large language model with user activity data and time objective tags to generate a summary of time spent on user activities according to time objectives (as an objective timeline report). Then, as shown in FIG. 15, the digital time objective assistant system 106 provides, for display within a graphical user interface 1504 of a client device 1502, an objective timeline report 1506 indicating an amount of time spent on user activities based on time objective tags (e.g., time objective 1, 2, 3).

Moreover, as shown in FIG. 15, the digital time objective assistant system 106 displays a selectable element 1508 to switch between a display type for the objective timeline report 1506 (e.g., a stacked graph or a relative graph) to modify the displayed objective timeline report 1506 to display the objective timeline report 1506 as a stacked graph versus a relative graph. Indeed, the digital time objective assistant system 106 can display the objective timeline report 1506 in a variety of formats, such as, but not limited to, bar graphs, pie charts, numerical statistics, and/or spreadsheets. Moreover, as also shown in FIG. 15, the digital time objective assistant system 106 displays a selectable element 1510 to enable the display of user activities that are uncategorized (e.g., not associated with a time objective). Indeed, the digital time objective assistant system 106 can display time spent on user activities that are uncategorized within the objective timeline report 1506.

Furthermore, as shown in FIG. 15, the digital time objective assistant system 106 can also display a time range selection element 1509 (e.g., as a slider element). Indeed, the digital time objective assistant system 106 can enable a user to select a time range for an objective timeline report. For instance, based on a selection of a time range (e.g., 4 weeks, 7 weeks, 10 weeks, 12 weeks), the digital time objective assistant system 106 can generate an objective timeline report based on the time range (by including the time range in the time expenditure prompt) in accordance with one or more implementations herein. Although FIG. 15 illustrates the digital time objective assistant system 106 displaying a slider tool element, the digital time objective assistant system 106 can display various selectable user interface elements (e.g., radio buttons, dropdown menus) to select time ranges and/or other options for a time expenditure prompt to generate and display a customized objective timeline report (in accordance with one or more implementations herein).

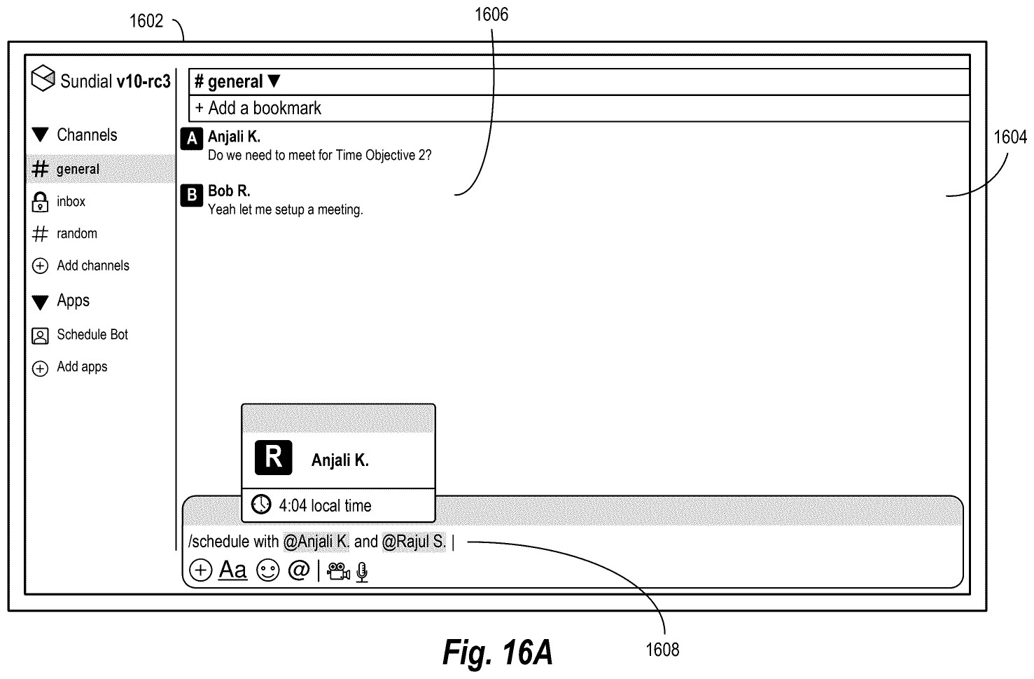

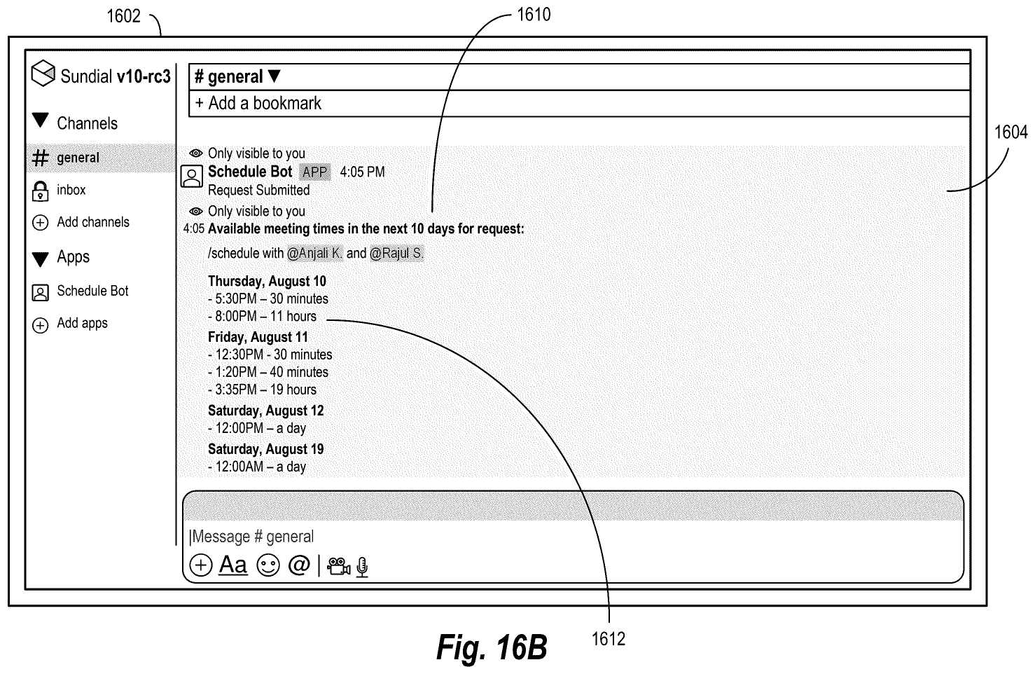

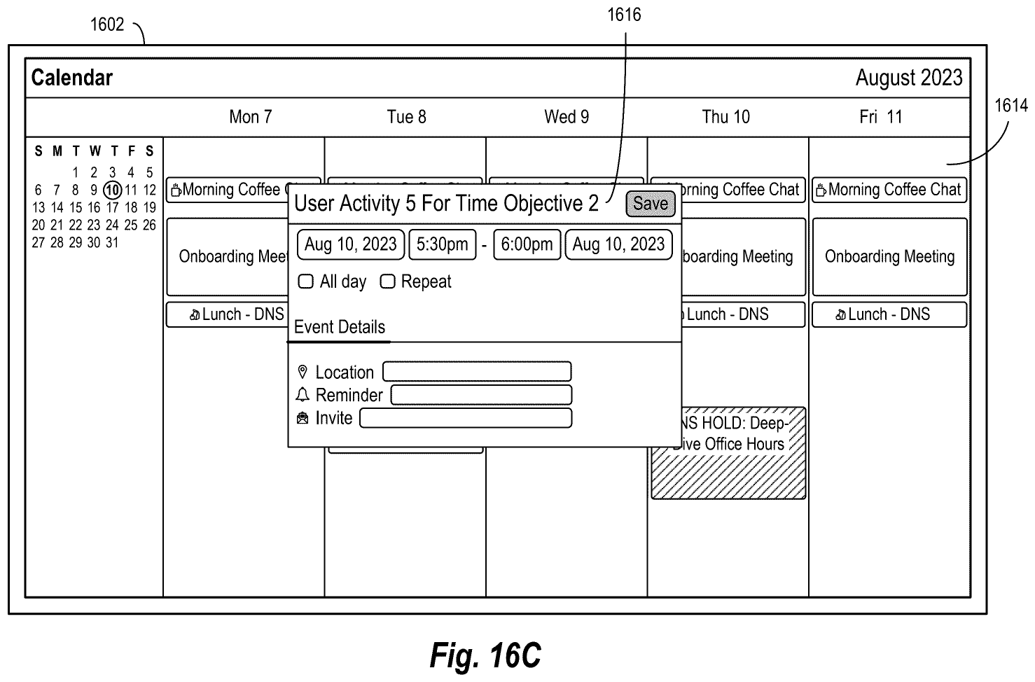

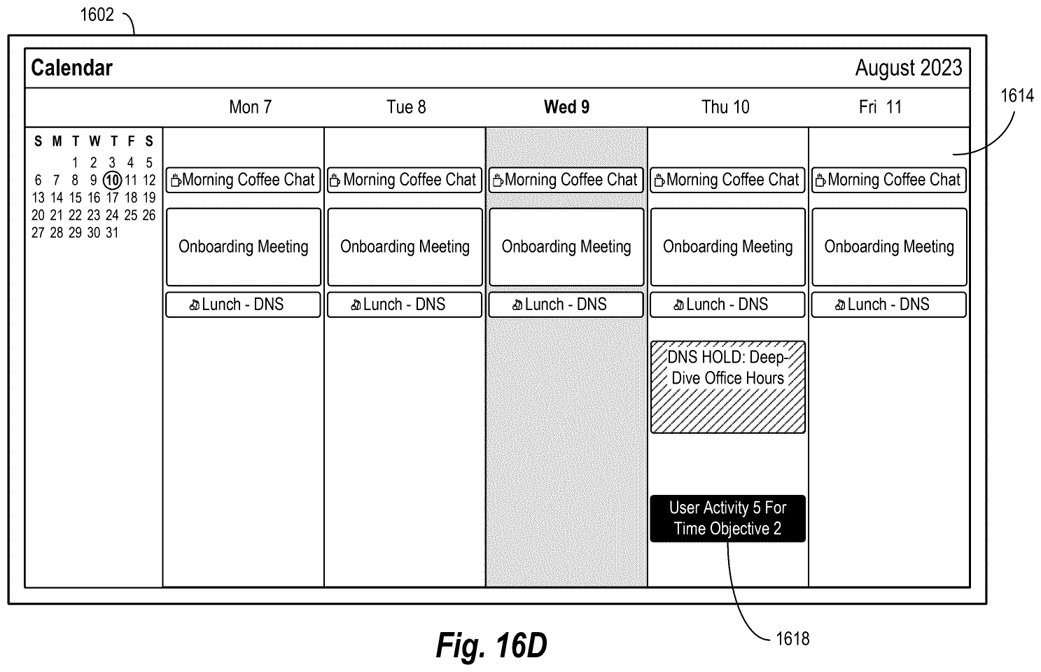

In one or more instances, the digital time objective assistant system 106 utilizes the scheduling assistant large language model to schedule one or more electronic calendar events (in accordance with one or more implementations herein). For instance, FIGS. 16A-16D illustrate the digital time objective assistant system 106 receiving and utilizing a user prompt to generate one or more electronic calendar events via the scheduling assistant large language model. For instance, as shown in FIG. 16A, the digital time objective assistant system 106 provides, for display within a graphical user interface 1604 of a client device 1602, a messaging interface 1606. Indeed, within the messaging interface 1606, the digital time objective assistant system 106 receives a text prompt 1608 (e.g., “/schedule with . . . ”). The digital time objective assistant system 106 can utilize the text prompt 1608 with the scheduling assistant large language model to schedule one or more electronic calendar events between mentioned user accounts (in accordance with one or more implementations herein).

For instance, as shown in the transition from FIG. 16A to FIG. 16B, the digital time objective assistant system 106 provides the text prompt 1608 to the scheduling assistant large language model and, in response, the scheduling assistant large language model outputs, within the graphical user interface 1604, a scheduling interface 1610 that includes selectable time slots 1612. Moreover, upon receiving a user selection of a selectable time slot from the selectable time slots 1612, the digital time objective assistant system 106 can schedule (or generate) an electronic calendar event based on the selected time slot. For instance, as shown in the transition from FIG. 16B to FIG. 16C, the digital time objective assistant system 106 displays a draft electronic calendar event 1616 within an electronic calendar user interface 1614 of the client device 1602. Indeed, as shown in FIG. 16C, the draft electronic calendar event 1616 displays the selected time slot from the selectable time slots 1612 and information for a user activity and time objective (e.g., based on the message thread between in the messaging interface 1606). In particular, as shown in the transition from FIG. 16C to FIG. 16D, the digital time objective assistant system 106 generates an electronic calendar event 1618 within the electronic calendar user interface 1614 (of the client device 1602) based on the text prompt 1608.

In one or more instances, the digital time objective assistant system 106 utilizes a user provided text prompt to schedule an electronic calendar event with a user account data stream and/or time objective data to generate a time expenditure prompt (as described above). Moreover, the digital time objective assistant system 106 utilizes the time expenditure prompt with a scheduling assistant large language model (in accordance with one or more implementations herein) to generate an electronic calendar event for the text prompt that accounts for user availability, availability of other users mentioned in the text prompt, time allocation suggestions for user activities and time objectives, time objective priorities, and/or other particular instructions in the user provided text prompt. Indeed, in some cases, the digital time objective assistant system 106 can also utilize the user provided text prompt and the messages within the messaging thread as part of the time expenditure prompt to determine a relevant time objective for the electronic calendar event and tag the electronic calendar event with the determined time objective. In some instances, the user text prompt can include a description of a time objective and/or user activity for the electronic calendar event.

Furthermore, in some instances, the digital time objective assistant system 106 generates fluid user activity events. Indeed, the digital time objective assistant system 106 can generate fluid user activity events that are modifiable (e.g., by the large language model) based on updates to one or more user account electronic calendar events, updates to time objective priorities, and/or one or more predicted time allocation suggestions for one or more user accounts. Indeed, FIG. 17 illustrates the digital time objective assistant system 106 utilizing a scheduling assistant large language model to generate and utilize fluid user activity events.

For instance, the digital time objective assistant system 106 can generate a fluid user activity event that is modifiable and is defined without specific dates and times such that the user activity event's concretization is predicted by the scheduling assistant large language model based on the user activity event's features in comparison to features of other user activities and scheduled events in a user account data stream. For instance, the digital time objective assistant system 106 can generate a fluid user activity event and schedule an electronic calendar event for the fluid user activity event. In addition, the digital time objective assistant system 106 can utilize the scheduling assistant large language model to check the fluid user activity event against changes in a user account schedule, time objective priorities, time allocation suggestions, and/or other generated electronic calendar events (in accordance with one or more implementations herein). Indeed, based on the comparison, the digital time objective assistant system 106 can modify the fluid user activity event's scheduled slot in an electronic calendar to fit the user account schedule, time objective priorities, time allocation suggestions, and/or other generated electronic calendar events (of one or more user accounts corresponding to the fluid user activity event).

To illustrate, in some cases, the digital time objective assistant system 106 can utilize the scheduling assistant large language model to generate a fluid user activity event that includes one or more fluid constraints on a future activity event (e.g., a recurring event, a one-time event). In particular, the digital time objective assistant system 106 can generate the fluid user activity event such that the fluid user activity event is concretized as a user activity event (e.g., within an electronic calendar) based on one or more triggering event horizons (or conditions). For instance, the digital time objective assistant system 106 can, via the scheduling assistant large language model, generate a fluid user activity event that is unpopulated in an electronic calendar (e.g., a floating event). Upon detection of one or more triggering event horizons corresponding to the fluid user activity event by the scheduling assistant large language model, the digital time objective assistant system 106 can generate (or schedule) an electronic calendar event slot for the fluid user activity event.

As an example, the digital time objective assistant system 106, via the scheduling assistant large language model, can generate a fluid user activity event with a triggering event horizon that indicates that the fluid user activity event is to be scheduled every four weeks. In response, the digital time objective assistant system 106 can, via the scheduling assistant large language model, concretize an electronic calendar event slot for the fluid user activity event to meet the triggering event horizon of four weeks. For instance, the digital time objective assistant system 106, via the scheduling assistant large language model, can generate an electronic calendar event slot for the fluid user activity event that accounts for changes in a user account schedule, time objective priorities, time allocation suggestions, and/or other generated electronic calendar events (in accordance with one or more implementations herein).

Furthermore, the digital time objective assistant system 106 can forego generating an additional electronic calendar event slots for the fluid user activity event beyond the triggering event horizon of four weeks. Upon passing another the triggering event horizon of four weeks (e.g., the time passing a four week threshold from a previously scheduled event for the fluid user activity event), the digital time objective assistant system 106 can generate an additional electronic calendar event slot for the fluid user activity event that accounts for changes in a user account schedule, time objective priorities, time allocation suggestions, and/or other generated electronic calendar events in the new four week horizon (in accordance with one or more implementations herein).

Although the above-mentioned example describes a triggering event horizon of four weeks, the digital time objective assistant system 106 can utilize a variety of triggering event horizons. For instance, the triggering event horizon can include a variety of threshold time frames (e.g., every 4 weeks, every 5 days, every month, every other month). In addition, the triggering event horizon can include a variety of other triggers, such as, but not limited to, a triggering event (e.g., scheduling a fluid user activity event upon detection of completion of another particular event, detection of a time objective deadline) and/or a triggering action (e.g., receiving a particular electronic communication from one or more target users, receiving one or more content item uploads, detecting completion of a particular task). In some cases, the triggering event horizon can include a scheduling threshold trigger that indicates an amount of available time (or calendar space) for a user account within a period of time and, for which, the digital time objective assistant system 106 can detect that a user account satisfies the scheduling threshold trigger based on the user account having a number of calendar events that exceed the amount of available time (e.g., indicating a risk of not having time for the fluid user activity event) or does not exceed the amount of available time (e.g., indicating that a user account has an excess of free time in a particular time frame). Indeed, based on detecting satisfaction of one or more of the triggering event horizons described above, the digital time objective assistant system 106, via the scheduling assistant large language model, can generate an electronic calendar event slot for the fluid user activity event while accounting for changes in a user account schedule, time objective priorities, time allocation suggestions, and/or other generated electronic calendar events (in accordance with one or more implementations herein).

In one or more instances, the digital time objective assistant system 106 can detect triggering event horizon data for a fluid user activity event from a fluid user activity definition. For instance, the digital time objective assistant system 106 can receive (e.g., via user input and/or the scheduling assistant large language model) a fluid user activity definition that include various combinations of an event name (e.g., a title, a description for the event), users for the event (e.g., one or more participants to invite), a frequency (e.g., recurring, one time), and/or constraints (e.g., morning time, no weekends, only Wednesdays). Furthermore, the fluid user activity definition can include one or more triggering event horizons, such as, but not limited to, a triggering event, a triggering action, a scheduling threshold trigger, and/or threshold time frames as described above.

As an example, the digital time objective assistant system 106 can generate and/or receive a fluid user activity event definition, such as “Title: “1:1 with User A,” “Recurrence: 30 minutes every 2 weeks,” and “restrictions: Mornings” (which includes a triggering event horizon of two weeks). As another example, the digital time objective assistant system 106 can generate and/or receive a fluid user activity event definition, such as “Title: Review Project A backlog” and “Recurrence: 1 hour every 2 weeks” (which includes a triggering event horizon of four weeks). Moreover, the digital time objective assistant system 106 can generate and/or receive a fluid user activity event definition, such as “Title: Debugging Action Items Review” and “When: 2 to 3 weeks from today” (which includes a triggering event horizon of 2 to 3 weeks from today). As another example, the digital time objective assistant system 106 can generate and/or receive a fluid user activity event definition, such as “Title: Review Project A” and “When: Upon content item upload to Folder A” (which includes a triggering event horizon via a triggering action of a content item upload to Folder A).

Indeed, as shown in FIG. 17, the digital time objective assistant system 106 utilizes a scheduling assistant large language model 1702 with fluid user activity events 1-N to generate electronic calendar events in an electronic calendar application 1706 of a client device 1704. For example, as shown in FIG. 17, the digital time objective assistant system 106 initially schedules a fluid user activity event time slot 1708a within the electronic calendar application 1706. Upon detecting a change in a user account schedule, time objective priorities, time allocation suggestions, and/or other generated electronic calendar events (in accordance with one or more implementations herein), the digital time objective assistant system 106 modifies the fluid user activity event time slot 1708a to a fluid user activity event time slot 1708b.

In some cases, the digital time objective assistant system 106 can detect a change in an electronic calendar event (e.g., for user activity 71). In response, digital time objective assistant system 106, via a scheduling assistant large language model, can modify a fluid user activity event time slot for a fluid user activity event in response to the detected change in the electronic calendar event such that the fluid user activity event does not overlap with the change in electronic calendar event (e.g., an event going over an allotted time, an event being moved). Indeed, the digital time objective assistant system 106 can modify various fluid user activity events within an electronic calendar application to adjust for changes in user account schedule, time objective priorities, time allocation suggestions, and/or other generated electronic calendar events (of one or more user accounts corresponding to the fluid user activity event).

In some instances, as shown in FIG. 17, the digital time objective assistant system 106 detects a satisfaction of one or more triggering event horizons (as described above) from triggering event horizon(s) 1712 corresponding to a fluid user activity event (e.g., fluid user activity event 2). In response to detecting the satisfaction of the one or more triggering event horizons, the digital time objective assistant system 106, via the scheduling assistant large language model 1702, schedules a fluid user activity event time slot 1710 within the electronic calendar application 1706. Indeed, as shown in FIG. 17, the digital time objective assistant system 106 can, upon satisfaction of the one or more triggering event horizons, generate the fluid user activity event time slot 1710 to fit a user account schedule, time objective priorities, time allocation suggestions, and/or other generated electronic calendar events (in accordance with one or more implementations herein).

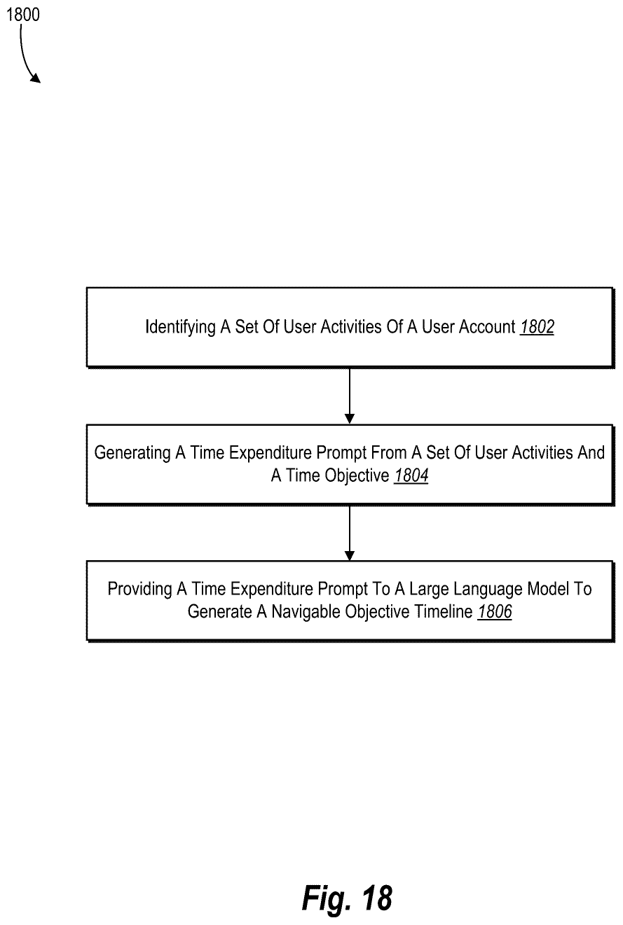

FIGS. 1-17, the corresponding text, and the examples provide a number of different methods, systems, devices, and non-transitory computer-readable media of the digital time objective assistant system 106. In addition to the foregoing, one or more implementations can also be described in terms of flowcharts comprising acts for accomplishing a particular result, as shown in FIG. 18. The acts shown in FIG. 18 may be performed in connection with more or fewer acts. Furthermore, the acts may be performed in differing orders. Additionally, the acts described herein may be repeated or performed in parallel with one another or parallel with different instances of the same or similar acts. A non-transitory computer-readable medium can comprise instructions that, when executed by one or more processors, cause a computing device to perform the acts of FIG. 18. In some implementations, a system can be configured to perform the acts of FIG. 18. Alternatively, the acts of FIG. 18 can be performed as part of a computer-implemented method.

FIG. 18 illustrates a flowchart of a series of acts 1800 for utilizing a large language model with user activity data to generate time objective timelines for user accounts in accordance with one or more implementations herein. While FIG. 18 illustrates acts according to one implementation, alternative implementations may omit, add to, reorder, and/or modify any of the acts shown in FIG. 18.

As shown in FIG. 18, the series of acts 1800 include an act 1802 of identifying a set of user activities of a user account, an act 1804 of generating a time expenditure prompt from a set of user activities and at time objective, and an act 1806 of providing a time expenditure prompt to a large language model to generate a navigable objective timeline.

In some embodiments, the series of acts 1800 can include generating, utilizing connectors to collect data from one or more applications corresponding to a user account, a data stream representing a set of user account activities of the user account across the one or more applications, determining, for the user account, a time objective (indicating a time constraint), generating, from the data stream and the time objective, a time expenditure prompt comprising parameters for converting the data stream into a displayable format based on the time objective, and providing the time expenditure prompt to a large language model to generate a navigable objective timeline comprising a subset of user account activities, from the data stream, contributing to the time objective.

Furthermore, the series of acts 1800 can include identifying a time objective for a user account (indicating a time constraint), generating, based on the time objective and a data stream comprising a set of user account activities for the user account, a time expenditure prompt comprising parameters for converting the data stream into a displayable format based on the time objective, and providing the time expenditure prompt to a large language model to generate a navigable objective timeline comprising a subset of user account activities contributing to the time objective.

In addition, the series of acts 1800 can include generating, utilizing connectors to collect data from one or more applications corresponding to a user account, a data stream representing a set of user account activities of the user account across the one or more applications, determining a time objective for the user account (indicating a time constraint), generating, from the data stream and the time objective, a time expenditure prompt comprising parameters for converting the data stream into a displayable format based on the time objective, and providing the time expenditure prompt to a large language model to generate a navigable objective timeline comprising one or more suggested time allocations for a subset of user account activities for the time objective.

In some implementations, the series of acts 1800 can include a set of user account activities that include communication activities, electronic calendar events, electronic task events, or content item events. Moreover, the series of acts 1800 can include one or more applications that include an electronic communication application, an electronic calendar application, or a content management application. Furthermore, the series of acts 1800 can include a time objective that includes a task descriptor representing one or more tasks to be completed within the time constraint.

Moreover, the series of acts 1800 can include determining relationships between user account activities in the data stream and the time objective. In addition, the series of acts 1800 can include determining relationships between user account activities in the set of user account activities and the time objective.

In addition, the series of acts 1800 can include identifying an additional time objective for the user account. Moreover, the series of acts 1800 can include determining to prioritize the time objective over the additional time objective. Furthermore, the series of acts 1800 can include determining to prioritize the time objective based on utilizing the large language model to learn time objective priorities for the time objective and the additional time objective from user account activities corresponding to the time objective and the additional time objective. In some cases, the series of acts 1800 can include determining to prioritize the time objective over the additional time objective based on utilizing the large language model to learn time objective priorities for the time objective and the additional time objective from the subset of user account activities corresponding to the time objective and an additional subset of user account activities corresponding to the additional time objective.

Additionally, the series of acts 1800 can include generating the time expenditure prompt based on the data stream, the time objective, and the additional time objective. Moreover, the series of acts 1800 can include providing the time expenditure prompt to the large language model to generate the navigable objective timeline to indicate a summary of time spent on time objective in comparison to an additional time spend on the additional time objective. In some instances, the series of acts 1800 can include providing the time expenditure prompt to the large language model to generate the navigable objective timeline to indicate a summary of time spent on time objective based on the subset of user account activities contributing to the time objective.

Furthermore, the series of acts 1800 can include utilizing the large language model with the time expenditure prompt to generate the navigable objective timeline to indicate suggested time allocations for the subset of user account activities for the time objective.

Additionally, the series of acts 1800 can include utilizing the large language model with the time expenditure prompt to generate one or more electronic calendar events for an electronic calendar application corresponding to the user account. Moreover, the series of acts 1800 can include utilizing the large language model to generate the one or more electronic calendar events with one or more additional user account participants associated with the time objective. In addition, the series of acts 1800 can include tagging one or more electronic calendar events based on the time objective.

In some cases, the series of acts 1800 can include generating one or more electronic calendar events for an electronic calendar application corresponding to the user account based on the one or more suggested time allocations. Furthermore, the series of acts 1800 can include utilizing the large language model to generate the one or more electronic calendar events with one or more additional user account participants associated with the time objective. Moreover, the series of acts 1800 can include utilizing the large language model with the time expenditure prompt to generate a fluid electronic calendar event, wherein the fluid electronic calendar event is modifiable by the large language model based on user account electronic calendar events, time objective priorities for the user account, or one or more predicted time allocations for the user account.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 19 illustrates a block diagram of exemplary computing device 1900 that may be configured to perform one or more of the processes described above. One will appreciate that server device(s) 102 and/or the client device 110 may comprise one or more computing devices, such as computing device 1900. As shown by FIG. 19, computing device 1900 can comprise processor 1902, memory 1904, storage device 1906, I/O interface 1908, and communication interface 1910, which may be communicatively coupled by way of communication infrastructure 1912. While an exemplary computing device 1900 is shown in FIG. 19, the components illustrated in FIG. 19 are not intended to be limiting. Additional or alternative components may be used in other embodiments. Furthermore, in certain embodiments, computing device 1900 can include fewer components than those shown in FIG. 19. Components of computing device 1900 shown in FIG. 19 will now be described in additional detail.

In particular embodiments, processor 1902 includes hardware for executing instructions, such as those making up a computer program. As an example and not by way of limitation, to execute instructions, processor 1902 may retrieve (or fetch) the instructions from an internal register, an internal cache, memory 1904, or storage device 1906 and decode and execute them. In particular embodiments, processor 1902 may include one or more internal caches for data, instructions, or addresses. As an example and not by way of limitation, processor 1902 may include one or more instruction caches, one or more data caches, and one or more translation lookaside buffers (TLBs). Instructions in the instruction caches may be copies of instructions in memory 1904 or storage device 1906.

Memory 1904 may be used for storing data, metadata, and programs for execution by the processor(s). Memory 1904 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 1904 may be internal or distributed memory.

Storage device 1906 includes storage for storing data or instructions. As an example and not by way of limitation, storage device 1906 can comprise a non-transitory storage medium described above. Storage device 1906 may include a hard disk drive (HDD), a floppy disk drive, flash memory, an optical disc, a magneto-optical disc, magnetic tape, or a Universal Serial Bus (USB) drive or a combination of two or more of these. Storage device 1906 may include removable or non-removable (or fixed) media, where appropriate. Storage device 1906 may be internal or external to computing device 1900. In particular embodiments, storage device 1906 is non-volatile, solid-state memory. In other embodiments, storage device 1906 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 1908 allows a user to provide input to, receive output from, and otherwise transfer data to and receive data from computing device 1900. I/O interface 1908 may include a mouse, a keypad or a keyboard, a touch screen, a camera, an optical scanner, network interface, modem, other known I/O devices or a combination of such I/O interfaces. I/O interface 1908 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interface 1908 is configured to provide graphical data to a display for presentation to a user. The graphical data may be representative of one or more graphical user interfaces and/or any other graphical content as may serve a particular implementation.

Communication interface 1910 can include hardware, software, or both. In any event, communication interface 1910 can provide one or more interfaces for communication (such as, for example, packet-based communication) between computing device 1900 and one or more other computing devices or networks. As an example and not by way of limitation, communication interface 1910 may include a network interface controller (NIC) or network adapter for communicating with an Ethernet or other wire-based network or a wireless NIC (WNIC) or wireless adapter for communicating with a wireless network, such as a WI-FI.

Additionally, or alternatively, communication interface 1910 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 1910 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 1910 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 1912 may include hardware, software, or both that couples components of computing device 1900 to each other. As an example and not by way of limitation, communication infrastructure 1912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 20 is a schematic diagram illustrating environment 2000 within which one or more embodiments of content management system 104 can be implemented. Content management system 2002 may generate, store, manage, receive, and send digital content (such as digital images and videos). For example, content management system 2002 may send and receive digital content to and from client devices 2006 by way of network 2004. In particular, content management system 2002 can store and manage a collection of digital content. Content management system 2002 can manage the sharing of digital content between computing devices associated with a plurality of users. For instance, content management system 2002 can facilitate a user sharing a digital content with another user of content management system 2002.

In particular, content management system 2002 can manage synchronizing digital content across multiple client devices 2006 associated with one or more users. For example, a user may edit digital content using client device 2006. The content management system 2002 can cause client device 2006 to send the edited digital content to content management system 2002. Content management system 2002 then synchronizes the edited digital content on one or more additional computing devices.

In addition to synchronizing digital content across multiple devices, one or more embodiments of content management system 2002 can provide an efficient storage option for users that have large collections of digital content. For example, content management system 2002 can store a collection of digital content on content management system 2002, while the client device 2006 only stores reduced-sized versions of the digital content. A user can navigate and browse the reduced-sized versions (e.g., a thumbnail of a digital image) of the digital content on client device 2006. In particular, one way in which a user can experience digital content is to browse the reduced-sized versions of the digital content on client device 2006.

Another way in which a user can experience digital content is to select a reduced-size version of digital content to request the full-or high-resolution version of digital content from content management system 2002. In particular, upon a user selecting a reduced-sized version of digital content, client device 2006 sends a request to content management system 2002 requesting the digital content associated with the reduced-sized version of the digital content. Content management system 2002 can respond to the request by sending the digital content to client device 2006. Client device 2006, upon receiving the digital content, can then present the digital content to the user. In this way, a user can have access to large collections of digital content while minimizing the number of resources used on client device 2006.

Client device 2006 may be a desktop computer, a laptop computer, a tablet computer, a personal digital assistant (PDA), an in-or out-of-car navigation system, a handheld device, a smart phone or other cellular or mobile phone, or a mobile gaming device, other mobile device, or other suitable computing devices. Client device 2006 may execute one or more client applications, such as a web browser (e.g., Microsoft Windows Internet Explorer, Mozilla Firefox, Apple Safari, Google Chrome, Opera, etc.) or a native or special-purpose client application (e.g., Dropbox for iPhone or iPad, Dropbox for Android, etc.), to access and view content over network 2004.

Network 2004 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 2006 may access content management system 2002.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
generating, utilizing connectors to collect data from one or more applications corresponding to a user account, a data stream representing a set of user account activities of the user account across the one or more applications;
determining a time objective for the user account;
generating, from the data stream and the time objective, a time expenditure prompt comprising parameters for converting the data stream into a displayable format based on the time objective; and
providing the time expenditure prompt to a large language model to generate a navigable objective timeline comprising a subset of user account activities, from the data stream, contributing to the time objective.

2. The computer-implemented method of claim 1, wherein:
the set of user account activities comprise communication activities, electronic calendar events, electronic task events, or content item events; and
the one or more applications comprise an electronic communication application, an electronic calendar application, or a content management application.

3. The computer-implemented method of claim 1, wherein the time objective comprises a task descriptor representing one or more tasks to be completed within a time constraint.

4. The computer-implemented method of claim 1, further comprising determining relationships between user account activities in the data stream and the time objective.

5. The computer-implemented method of claim 1, further comprising:
identifying an additional time objective for the user account; and
determining to prioritize the time objective over the additional time objective.

6. The computer-implemented method of claim 5, further comprising determining to prioritize the time objective based on utilizing the large language model to learn time objective priorities for the time objective and the additional time objective from user account activities corresponding to the time objective and the additional time objective.

7. The computer-implemented method of claim 5, further comprising:
generating the time expenditure prompt based on the data stream, the time objective, and the additional time objective; and
providing the time expenditure prompt to the large language model to generate the navigable objective timeline to indicate a summary of time spent on time objective in comparison to an additional time spend on the additional time objective.

8. The computer-implemented method of claim 1, further comprising utilizing the large language model with the time expenditure prompt to generate the navigable objective timeline to indicate suggested time allocations for the subset of user account activities for the time objective.

9. The computer-implemented method of claim 1, further comprising utilizing the large language model with the time expenditure prompt to generate one or more electronic calendar events for an electronic calendar application corresponding to the user account.

10. The computer-implemented method of claim 9, further comprising utilizing the large language model to generate the one or more electronic calendar events with one or more additional user account participants associated with the time objective.

11. The computer-implemented method of claim 9, further comprising tagging one or more electronic calendar events based on the time objective.

12. A non-transitory computer-readable medium storing instructions that, when executed by at least one processor, cause a computing device to:
identify a time objective for a user account;
generate, based on the time objective and a data stream comprising a set of user account activities for the user account, a time expenditure prompt comprising parameters for converting the data stream into a displayable format based on the time objective; and
provide the time expenditure prompt to a large language model to generate a navigable objective timeline comprising a subset of user account activities contributing to the time objective.

13. The non-transitory computer-readable medium of claim 12, further comprising instructions that, when executed by the at least one processor, cause the computing device to determine relationships between user account activities in the set of user account activities and the time objective.

14. The non-transitory computer-readable medium of claim 12, further comprising instructions that, when executed by the at least one processor, cause the computing device to:
identify an additional time objective for the user account; and
determine to prioritize the time objective over the additional time objective based on utilizing the large language model to learn time objective priorities for the time objective and the additional time objective from the subset of user account activities corresponding to the time objective and an additional subset of user account activities corresponding to the additional time objective.

15. The non-transitory computer-readable medium of claim 12, further comprising instructions that, when executed by the at least one processor, cause the computing device to provide the time expenditure prompt to the large language model to generate the navigable objective timeline to indicate a summary of time spent on time objective based on the subset of user account activities contributing to the time objective.

16. The non-transitory computer-readable medium of claim 12, further comprising instructions that, when executed by the at least one processor, cause the computing device to generate the navigable objective timeline to indicate suggested time allocations for the subset of user account activities for the time objective or generate one or more electronic calendar events for an electronic calendar application corresponding to the user account.

17. A system comprising:
at least one processor; and
at least one non-transitory computer-readable storage medium storing instructions that, when executed by the at least one processor, cause the system to:
generate, utilizing connectors to collect data from one or more applications corresponding to a user account, a data stream representing a set of user account activities of the user account across the one or more applications;
determine a time objective for the user account;
generate, from the data stream and the time objective, a time expenditure prompt comprising parameters for converting the data stream into a displayable format based on the time objective; and
provide the time expenditure prompt to a large language model to generate a navigable objective timeline comprising one or more suggested time allocations for a subset of user account activities for the time objective.

18. The system of claim 17, further comprising instructions that, when executed by the at least one processor, cause the system to generate one or more electronic calendar events for an electronic calendar application corresponding to the user account based on the one or more suggested time allocations.

19. The system of claim 18, further comprising instructions that, when executed by the at least one processor, cause the system to utilize the large language model to generate the one or more electronic calendar events with one or more additional user account participants associated with the time objective.

20. The system of claim 17, further comprising instructions that, when executed by the at least one processor, cause the system to utilize the large language model with the time expenditure prompt to generate a fluid electronic calendar event, wherein the fluid electronic calendar event is modifiable by the large language model based on user account electronic calendar events, time objective priorities for the user account, or one or more predicted time allocations for the user account.
